(19) United States
(12) Patent Application Publication
(10) Pub. No.: US 2026/0066262 A1
(43) Pub. Date: Mar. 5, 2026

(54) SOLID ELECTROLYTE-ELECTRODE ASSEMBLY, METHODS FOR MAKING, AND AN ALL-SOLID-STATE BATTERY THEREOF

(71) Applicants: LG ENERGY SOLUTION, LTD., Seoul (KR); The Regents of the University of California, Oakland, CA (US)

(72) Inventors: Jung-Pil LEE, Daejeon (KR); Jiyoung KIM, Daejeon (KR); Dong Ju LEE, La Jolla, CA (US); Zheng CHEN, San Diego, CA (US); Min-Sang SONG, Daejeon (KR)

(73) Assignees: LG ENERGY SOLUTION, LTD., Seoul (KR); The Regents of the University of California, Oakland, CA (US)

(21) Appl. No.: 19/315,180

(22) Filed: Aug. 29, 2025

Related U.S. Application Data
(63) Continuation-in-part of application No. 18/821,654, filed on Aug. 30, 2024.

(51) Int. Cl. H01M 4/04; H01M 4/02; H01M 10/0525; H01M 10/0585

(52) U.S. Cl. CPC H01M 4/0435; H01M 10/0525; H01M 10/0585; H01M 2004/021; H01M 2004/028

(57) ABSTRACT

A solid electrolyte-electrode assembly, as well as an all-solid-state battery including the assembly are described. For instance, a solid electrolyte-cathode assembly can be formed by co-rolling a plurality of cathode particles and a plurality of solid electrolyte particles, which results in the simultaneous production of the assembly and makes it possible to achieve improved interface resistance between the electrolyte membrane and electrode to improve battery performance. Also, the resulting electrolyte can be thin, which improves the energy density, while also maintaining excellent strength by using an electrode as a support.

### CROSS-REFERENCE TO RELATED APPLICATION

The present application claims priority to U.S. application Ser. No. 18/821,654 filed Aug. 30, 2024, the entire contents of which are herein expressly incorporated by reference.

### FIELD OF TECHNOLOGY

The present disclosure relates to a solid electrolyte-electrode assembly, as well as an all-solid state battery (“ASSB”) thereof. The solid electrolyte-cathode assembly can be formed by co-rolling a plurality of cathode particles and a plurality of solid electrolyte particles, which results in the simultaneous production of the solid electrolyte-electrode assembly. In some aspects, the co-rolling dry-process establishes a sustainable and scalable fabrication for improved interface design strategies, for the practical application of ASSBs.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

Conventional liquid lithium-ion batteries were critical to the advancement of electrified transportation and energy storage systems, and have had a significant and positive impact on green energy and climate change mitigation efforts. While such conventional liquid lithium-ion batteries are superior to many other energy sources, liquid lithium-ion batteries also have certain limitations. For example, various safety mechanisms are critical for lithium-ion batteries to restrict voltage and internal pressures, but these safety features typically result in increased weight and performance limitations in certain instances. Moreover, lithium-ion batteries are susceptible to aging, leading to capacity loss and eventually failure after a number of years of use.

In an all-solid-state battery (ASSB), a solid electrolyte is used instead of a liquid electrolyte, making the entire battery solid. The solid electrolyte is intrinsically non-flammable and can accommodate a wider temperature range, allowing it to function as electrochemical energy storage without the need for additional safety devices. Solid state batteries, which offer higher energy density, are safer than batteries with a liquid electrolyte system, such as conventional lithium-ion batteries. In a conventional solid state battery, a solid electrolyte replaces a liquid electrolyte system, and thus reduces the risk of ignition or explosion, thereby increasing safety.

For example, lithium-sulfur batteries using lithium and an alkali metal as an anode active material and sulfur as a cathode active material have a theoretical energy density of 2,800 Wh/kg (1,675 mAh), which is significantly higher than those of other battery systems, and have received attention as portable electronic devices due to an advantage in that sulfur is inexpensive due to the abundance in resources, and an environmentally-friendly material. Lithium metal is advantageous because it is lightweight and has high energy density, and various cathode active materials may be used for lithium batteries, including sulfur-containing cathode active materials having sulfur-sulfur bonds, which have high energy capacities. However, when sulfur is used as a cathode active material for a lithium-sulfur battery, it is a non-conductor, making it difficult for electrons produced by an electrochemical reaction to move. Also, in the case of sulfur anode, due to the large volume change during charging and discharging, there is an issue with reduced performance and lifetime.

Therefore, there is a high need for a technology to increase energy density, improve cycle characteristics and lifetime in an ASSB technology.

Furthermore, there is a need to avoid the use of toxic solvents, which pose safety risks, require solvent drying and recovery steps that may be energy intense and environmentally unsustainable. In addition, there could be chemical incompatibility of organic solvents with certain solid-state electrolytes (“SSEs”). Therefore, there is a need for a robust, sustainable dry-process method for fabrication and for eliminating organic solvents.

### SUMMARY

The present disclosure relates to a solid electrolyte-cathode assembly for use in an ASSB technology. The solid electrolyte-cathode assembly can be formed by co-rolling a plurality of cathode particles and a plurality of solid electrolyte particles, which results in the simultaneous production of the assembly. It is possible to achieve improved interface resistance between the electrolyte membrane and electrode, which improves battery performance. Also, the electrolyte can be much thinner, which improves the energy density, while also maintaining excellent strength.

A method for manufacturing a solid electrolyte-cathode assembly is described, which comprises: providing a plurality of cathode particles; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly, wherein the solid electrolyte-cathode assembly comprises a cathode layer having a thickness less than 200 μm, wherein the cathode layer structurally supports the solid electrolyte layer; wherein a ratio of a thickness of the cathode layer to a thickness of the solid electrolyte layer is from 1:1 to 20:1.

A method for manufacturing a solid electrolyte-cathode assembly is described, which comprises: providing a plurality of cathode particles, wherein the cathode particles have an average particle size of 0.1 μm to 20 μm; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly, wherein the co-rolling process is conducted at a speed of about 1 m/min to 10 m/min, wherein the co-rolling produces a network-reinforced interface between the solid electrolyte and the cathode in the solid electrolyte-cathode assembly, wherein the solid electrolyte-cathode assembly comprises a cathode layer having a thickness of more than 10 μm and less than 200 μm; wherein an amount of the binder is less than 1%, such that contact between the cathode layer and the solid electrolyte layer is increased; and wherein a ratio of a thickness of the cathode layer to a thickness of the solid electrolyte layer is from 1:1 to 20:1.

A solid electrolyte-cathode assembly is described, prepared by: providing a plurality of cathode particles; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly, wherein the solid electrolyte-cathode assembly comprises a cathode layer having a thickness of more than 10 μm and less than 200 μm; wherein the solid electrolyte-cathode assembly does not have a current collector; wherein an amount of the binder is less than 1%, such that contact between the cathode layer and the solid electrolyte layer is increased; and wherein a ratio of a thickness of the cathode layer to a thickness of the solid electrolyte layer is from 1:1 to 20:1.

A method for manufacturing a solid electrolyte-cathode assembly is described, which comprises: providing a plurality of cathode particles; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly. In some aspects, the solid electrolyte-cathode assembly may comprise a cathode layer having a thickness less than 50 μm and a solid electrolyte layer having a thickness less than 50 μm, such that the cathode layer structurally supports the solid electrolyte layer. In some aspects, an amount of binder is less than 1%, such that contact between the cathode layer and the solid electrolyte layer is increased. In some aspects, a ratio of a thickness of the cathode layer to a thickness of the solid electrolyte layer is from 1:1 to 1:5, e.g., in some aspects such that an interface resistance between the cathode layer and the solid electrolyte layer is reduced.

A method for manufacturing a solid electrolyte-cathode assembly is described, which comprises: providing a plurality of cathode particles, wherein the cathode particles comprise a lithium nickel manganese cobalt oxide; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly. In some aspects, the solid electrolyte-cathode assembly can comprise a cathode layer having a thickness of more than 10 μm and less than 50 μm and a solid electrolyte layer having a thickness of more than 10 μm and less than 50 μm, such that the cathode layer structurally supports the solid electrolyte layer; the amount of binder is less than 1%, such that contact between the cathode layer and the solid electrolyte layer is increased; and a ratio of a thickness of the cathode layer to a thickness of the solid electrolyte layer is from 1:1 to 1:5 e.g., in some aspects such that an interface resistance between the cathode layer and the solid electrolyte layer is reduced.

A solid electrolyte-cathode assembly is described, which can be prepared by: providing a plurality of cathode particles; providing a solid electrolyte, wherein the solid electrolyte is provided in the form of particles having an average particle size less than 5 m; providing a binder; and co-rolling the plurality of cathode particles, the solid electrolyte, and the binder, under conditions to form the solid electrolyte-cathode assembly. In some aspects, the solid electrolyte-cathode assembly comprises a cathode layer having a thickness of more than 10 μm and less than 50 μm and a solid electrolyte layer having a thickness of more than 10 μm and less than 50 μm, such that the cathode layer structurally supports the solid electrolyte layer; the amount of binder is less than 1%, such that contact between the cathode layer and the solid electrolyte layer is increased; and a ratio of a thickness of the cathode layer to a thickness of the solid electrolyte layer is from 1:1 to 1:5 e.g., in some aspects such that an interface resistance between the cathode layer and the solid electrolyte layer is reduced. In some aspects, the co-rolling dry-process significantly enhances the mechanical stability of a thin SSE layer from film fabrication to cell operation along with robust SSE-positive electrode interface.

An all-solid-state battery is described, which comprises the solid electrolyte-cathode assembly described herein. In some aspects, the all-solid-state battery operates at a low stack pressure, e.g., a stack pressure of about 2 MPa or lower.

In some aspects, the solid electrolyte-cathode assembly does not have a current collector. For instance, a cathode current collector such as aluminum (Al) is not needed.

In some aspects, the solid electrolyte-cathode assembly has a porosity great than about 10%

In some aspects, an amount of binder is less than 2%, less than 1%, less than 0.5%, less than 0.1%, less than 0.05%, and greater than 0%, greater than 0.01%, greater than 0.05%, or greater than 0.1%. In some embodiments, only a very small amount of binder needed, because there is a supporting cathode layer in the resulting solid electrolyte-cathode assembly. In some aspects, the amount of binder may be more than 0%, more than 0.05%, or more than 0.1%.

In some aspects, the cathode particles have an average particle size of 0.1 μm to 20 μm; 0.1 μm to 10 μm; 1 μm to 5 μm; or 1 μm to less than 5 μm. For example, the cathode particles can be in the sub-micron to micron range.

In some aspects, the cathode layer has a thickness of greater than or equal to 25 μm, a thickness of greater than or equal to 15 μm, a thickness of greater than or equal to 10 μm, a thickness of greater than or equal to 7 μm or a thickness of greater than or equal to 5 μm. In some aspects, the cathode layer has a thickness less than 100 μm, less than 90 μm, less than 80 μm, less than 70 μm, less than 60 μm, or less than 50 μm. In some embodiments, the cathode has a thickness of about 25 μm to about 200 μm, or a thickness of about 50 μm to about 150 μm.

In some aspects, in the solid electrolyte-cathode assembly, the solid electrolyte layer has a thickness less than 50 μm, less than 40 μm, less than 30 μm or less than 20 μm.

Some aspects relate to where the ratio of a thickness for the cathode layer to a thickness of the solid electrolyte layer (in the solid electrolyte-cathode assembly) is from about 1:1 to 1:5, from about 1:1 to 1:4, from about 1:1 to 1:3, from about 1:1 to 1:2, or about 1:1. In some aspects, a ratio of a thickness of the cathode layer to a thickness of the solid electrolyte layer is from 1:1 to 10:1. The ratio of a thickness for the cathode layer to a thickness of the solid electrolyte layer may be controlled to improve the layer uniformity and/or surface quality of the resulting solid electrolyte-cathode assembly.

In some aspects, in the solid electrolyte-cathode assembly, a weight ratio of the cathode particles to the solid electrolyte is from 1:1 to 1:5. In some aspects, a weight ratio of the cathode particles to the solid electrolyte is about 1:2. In some aspects, a weight ratio of the plurality of cathode particles to the solid electrolyte is from 1:1 to 10:1.

In some aspects, the method for making the solid electrolyte-cathode assembly is carried out under dry processing conditions.

In some aspects, the method for making the solid electrolyte-cathode assembly includes co-rolling at a temperature of from about room temperature to about 120° C.

In some aspects, the co-rolling process is used to construct a robust SSE-positive electrode interface that can be useful to reduce operation pressure in all-solid-state batteries (“ASSBs”). That is, reducing operation or stack pressure is a critical challenge to the practical implementation of ASSBs. Volume change of active materials during de-lithiation/lithiation can lead to void formation, resulting in loss of contact between SSE and active materials. This mechanical degradation increases cell polarization, thus lowering the capacity utilization. While high stack pressures (>50 MPa) can be used in laboratory testing to ensure particle-to-particle contacts, recent research has pivoted towards achieving stable cycling performance even at reduced stack pressures. For instance, viscoelastic SSEs may enhance SSE-positive electrode contacts and reduce operation pressure. Further, ductile halide SSEs and optimal positive electrode composite design may also be effective under low-pressure operation. In some aspects, these materials can be used to provide processable films and eventually large-scale pouch cells, for the practical implementation of ASSBs.

### BRIEF DESCRIPTION OF THE DRAWINGS

The accompanying drawings illustrate aspects of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIGS. 1A and 1B show a Comparative Example formed according to a conventional method where there is a problem of mechanical failure when using a thin solid-state electrolyte (“SSE”) to form an assembly due to poor mechanical property of the film. FIGS. 1C and 1D show an Example according to disclosed aspects where the solid electrolyte-electrode assembly is formed by co-rolling a plurality of cathode particles and a plurality of solid electrolyte particles, which results in the simultaneous production of the assembly and mitigates mechanical failure of the thin SSE layer. FIG. 1E shows that assuming a linear relationship between the thickness and mechanical property of the film, the risk of mechanical failure increases as the thickness of the film decreases, which makes fabricating a thin but robust SSE film difficult.

FIGS. 2A and 2B illustrate solid electrolyte-cathode assemblies formed according to an example (FIG. 2A) and a Comparative Example (FIG. 2B). FIG. 2A shows a thin SSE co-rolled film fabricated co-rolling dry-process showing SSE and positive electrode sides with crack-free surface. FIG. 2B shows a thin SSE freestanding film fabricated with conventional dry-process showing severe crack and tear.

FIG. 2C shows photos of SSE (bright yellow) and positive electrode (gray) sides of co-rolled film prepared with different fabrication parameters after press: (a) PC-NCM/120° C./20 μm, (b) SC-NCM/120° C./20 μm, (c) SC-NCM/30° C./20 μm, and (d) SC-NCM/120° C./100 μm. The slight difference in color is due to different angles and intensity of light.

FIGS. 3A and 3B show the physical and mechanical characterizations of co-rolled film and interface. FIG. 3A shows the results from a flexibility test of co-rolled film.

FIG. 3B shows the results from tensile strength measurement of SSE and positive electrode freestanding films and co-rolled film. Data are presented as mean values with standard deviation, n=5 independent replicates. FIG. 3C shows a schematic illustrating shearing effect on the interface including binder fibrillation and contact formation. In these figures, yellow spheres represent SSE and gray spheres represent CAM.

FIGS. 4A-H show the electrochemical characterizations of the co-rolled film. FIGS. 4A, 4B, 4C, and 4D illustrate the electrochemical characterizations of solid electrolyte-cathode assemblies formed according to an Example according to disclosed aspects and a Comparative Example, including schematic illustrations of the Example (FIGS. 4A and 4B), a schematic illustration of the Comparative Example (FIG. 4B), lithium ion transport characteristics in the solid electrolyte for the Example and Comparative Example (FIG. 4C), and lithium ion transport characteristics in the cathode for the Example and Comparative Example (FIG. 4D). FIG. 4A shows a schematic illustrating Li⁺ and e⁻ transports in SSE and positive electrode layers, and cell properties affected by such transports. FIG. 4B shows a co-rolled film and freestanding films used for the characterization. FIGS. 4C-F show data relating to the evaluation of Li⁺ and e⁻ transports in SSE and positive electrode layers of co-rolled film and freestanding films. For instance, FIG. 4C shows Li⁺ transport in SSE layer, FIG. 4D shows e transport in SSE layer, FIG. 4E shows Li⁺ transport in positive electrode layer, and FIG. 4F shows e− transport in positive electrode layer, comparing cells assembled with co-rolled film and freestanding films. FIGs. G-H show an evaluation of cell properties of cells assembled with co-rolled film and freestanding films, where FIG. G shows internal resistance, and FIG. 4H shows the shelf-life, when comparing cells assembled with co-rolled film and freestanding films. All tests were conducted at 23±1° C.

FIGS. 5A-J show details of the fabrication process and parameters of co-rolling dry process in some aspects. FIG. 5A shows a schematic illustrating three fabrication steps (S1-3) and parameters (P1-3). FIG. 5B and FIG. 5C show an SEM image of positive electrode side of co-rolled film fabricated with (FIG. 5B) large PC-NCM and (FIG. 5C) small SC-NCM. FIG. 5D and E show cross-sectional SEM images of co-rolled film fabricated with (FIG. 5D) 30° C. and (FIG. 5E) 120° C. co-rolling temperatures. FIG. 5F and G show a cross-sectional SEM image of co-rolled film fabricated with (FIG. 5F) 100 μm and (FIG. 5G) 20 μm reduction thicknesses. FIG. 5H and I show SEM images of as-fabricated and pressed co-rolled film with optimized fabrication parameters and EDS mapping of (FIG. 5H) SSE side and (FIG. 5I) positive electrode side. FIG. 5J shows a micro-CT reconstruction of co-rolled film.

FIG. 6 relates to the electrochemical performance of co-rolled film. FIG. 6 shows long-term cycling of co-rolled film and freestanding films at 1 C (200 mA g⁻¹) under 75 MPa and 60° C.

FIGS. 7A-E shows a demonstration of high-energy density ASSBs. FIG. 7A shows cross-sectional SEM image of high-energy density cell assembled with co-rolled film and Si. FIG. 7B shows a rate test at 0.1, 0.2, 0.3, 0.4, 0.5 C (20, 40, 60, 80, 100 mA g⁻¹, respectively) under 23±1° C. and 75 MPa. FIG. 7C shows specific energy projection of NCM82|LPSCl| Si cell with current collectors (CC) with varying SSE thickness and areal loading. FIG. 7D shows cell assembly and fabrication of all-solid-state pouch cell with co-rolled film and Si by cold isostatic press (CIP). FIG. 7E shows cycling performance of pouch cell at 0.1 C (20 mA g⁻¹) under 30° C. and 5 MPa.

FIG. 8 shows the particle size of PC-NCM and SC-NCM. SEM images of (a, b) PC-NCM and (c, d) SC-NCM at low and high magnification, respectively.

FIG. 9 shows particle size and electrochemical properties of pristine and ball-milled LPSCl. SEM images of (a, b) pristine LPSCl and (c, d) ball-milled LPSCl at low and high magnification, respectively. (e) electrochemical impedance spectroscopy (EIS) of ionic conductivity measurement and (f) direct current polarization (DCP) of electronic conductivity measurement of pristine and ball-milled LPSCl. Both ionic and electronic conductivities were maintained after ball-milling. The tests were conducted at 23±1° C.

FIG. 10 shows the effect of PTFE binder ratio in positive electrode composite. (a) Voltage profiles of positive electrode films in LiIn|LPSCl|NCM configuration with different ratios of PTFE binder at 0.1 C (20 mA g-1). (b) Li⁺ transport and (c) e− transport properties obtained from electron-blocking and electron-nonblocking cell configurations, respectively. The ionic conductivities were calculated to be 0.069, 0.024, 0.007 mS cm-1, and electronic conductivities were calculated to be 34, 4.5, 0.011 mS cm-1 for PTFE ratios of 0.5, 2, 5 wt %, respectively. The weight ratio of CAM:SSE:VGCF was fixed to 80:17:3.

FIG. 11 shows surface morphologies of co-rolled film with PC-NCM. SEM images of positive electrode side of co-rolled film with PC-NCM (a, b) as-fabricated, (c, d) pressed with secondary electron (SE) mode, and (e, f) pressed with back scattered electron (BSE) mode at low and high magnification, respectively.

FIG. 12 shows surface morphologies of co-rolled film with SC-NCM. SEM images of positive electrode side of co-rolled film with SC-NCM (a, b) as-fabricated, (c, d) pressed with SE mode, and (e, f) pressed with BSE mode at low and high magnification, respectively.

FIG. 13 shows surface morphology of PC-NCM and SC-NCM at 300 and 500 MPa fabrication pressures. SEM images of powder positive electrode composite with PC-NCM fabricated at (a-c) 300 MPa and (d-f) 500 MPa and SC-NCM fabricated at (g-i) 300 MPa and (j-1) 500 MPa.

FIG. 14 shows the electrochemical properties of PC-NCM and SC-NCM at 300 and 500 MPa fabrication pressures. (a, d) Voltage profiles at 0.1 C (20 mA g-1), (b, e) rate test at 0.1, 0.2, 0.3, 0.5, 1 C (20, 40, 60, 100, 200 mA g-1, respectively), and (c, f) EIS of PC-NCM and SC-NCM in LiIn|LPSCl|NCM configuration, respectively, fabricated at 300 and 500 MPa. SC-NCM fabricated at 500 MPa showed the lowest polarization, highest rate capability, and lowest impedance.

FIG. 15 shows dynamic mechanical analysis (DMA) measurement of PTFE. 67% decrease in storage modulus is obtained from 30 to 120° C.

FIG. 16 shows potential high-throughput capability of co-rolling dry-process. (a) Photos of co-rolled film fabricated at line speed of 4 μm min⁻¹.

FIG. 17 shows cross-sectional interphase analysis of co-rolled film. (a) SEM image and (b-d) EDS mapping of SSE-positive electrode interface of co-rolled film after press.

FIG. 18 shows XRD patterns of SSE side and positive electrode side of co-rolled film.

FIG. 19 shows an XPS analysis of SSE and positive electrode sides of co-rolled film. (a) S 2p, (b) Cl 2p, (c) Ni 2p spectra of SSE side and positive electrode side of co-rolled film.

FIG. 20 shows folding and unfolding test of co-rolled film. Photos of co-rolled films (a) folded inward SSE side and (b) folded inward positive electrode side.

FIG. 21 shows pressure changes of co-rolled film and freestanding films. Monitored pressure change of (a) co-rolled film and (b) freestanding films in LTO|LPSCl|NCM configuration at 75 MPa for 20 cycles. The cell with co-rolled film showed less pressure decrease than that with freestanding films (approximately −2 MPa vs. −3 MPa). The cells were cycled at 0.2 C (40 mA g-1) at 23° C.

FIG. 22 shows a co-rolled film full-cell with Si, including: (a) Voltage profile and (b) Coulombic efficiency. The test was carried out at 0.1, 0.2, 0.3, 0.4, 0.5 C (20, 40, 60, 80, 100 mA g-1, respectively).

FIG. 23 shows data relating to pouch cells of co-rolled film and freestanding films, including: (a) Comparison of cycling performance of pouch cells assembled with co-rolled film and freestanding films in Si|LPSCl|NCM configuration at 0.1 C (20 mA g⁻¹) with activation at 0.05 C (10 mA g⁻¹). Voltage profiles of (b) co-rolled film and (c) freestanding films.

FIG. 24 shows electrochemical characterizations of co-rolled film. Cell configurations and electrochemical methods used for the characterization of (a) Li+ transport in SSE, (b) e− transport in SSE, (c) Li+ transport in positive electrode, and (d) e− transport in positive electrode. Comparison of measurement results on (e) EIS and (f) DCP between SSE and SSE|electrode configurations. Li+ and e− transports in SSE were conducted with SSE|electrode structure due to the intrinsically integrated structure of co-rolled film. The high e− conductivity of electrode layer (>30 mS cm-1) showed negligible impacts on the bulk impedance of EIS for Li+ transport in SSE and the current measured of DCP for e− transport in SSE. For Li+ transport in positive electrode, powder SSE was used for freestanding films, and partial power SSE and SSE layer of co-rolled film were used for co-rolled film. The overall thickness of SSE layers was fixed. For e− transport in positive electrode, SSE layer of co-rolled film was carefully separated from positive electrode layer by peeling-off with tapes. The tests were conducted at 23±1° C.

FIG. 25 shows equivalent circuits used to analyze EIS results. (a) Li⁺ transport in SSE in FIG. 4c and (b) Li⁺ transport in positive electrode in FIG. 4e.

FIG. 26 shows the results from an internal resistance test, including: (a) Voltage curves of internal resistance test of co-rolled and freestanding films in Si|LPSCl|NCM configuration with respect to time in FIG. 4g. Zoomed-in voltage responses of (b) 1 C (200 mA g-1) charge and (c) 1 C (200 mA g-1) discharge. The tests were conducted at 23±1° C.

FIG. 27 shows data from a stack pressure test including: (a) EIS measurements obtained at different stack pressures. Voltages profiles of co-rolled and freestanding films in LiIn|LPSCl|NCM configuration cycled at 0.1 C (20 mA g-1) with stack pressures of (b) 75 MPa and (c) 2 MPa.

FIG. 28 shows an in situ observation of SSE-positive electrode resistance evolution of co-rolled films and freestanding films at 2 MPa. EIS measurement and DRT analysis, respectively, of (a, b) discharge process and (c, d) charge process of co-rolled film. EIS measurement and DRT analysis, respectively, of (e, f) discharge process and (g, h) charge process of freestanding films. Half-cells using LiIn|LPSCl|NCM configuration were cycled at 0.1 C (20 mA g-1) at 23° C.

FIG. 29 shows electrochemical performance of different CAM ratios at 75 and 2 MPa. (a-c) Voltage profiles at 0.1 C (20 mA g-1) and (d-f) rate test at 0.1, 0.2, 0.3, 0.5, 1 C (20, 40, 60, 100, 200 mA g-1, respectively) of different CAM ratios of 60, 70, and 80 wt %, respectively, in LiIn|LPSCl|NCM configuration.

FIG. 30 shows cell design and pressurization methods used to evaluate long-term cycling stability of SSE-positive electrode structures, including: (a) A schematic of LTO|LPSCl|NCM configuration with their volume change during charging. Photos of (b) fixed gap setup and (c) constant pressure setup. Monitored pressure changes during cell operation of (d) 75 MPa—fixed gap, (e) 2 MPa—fixed gap, and (f) 2 MPa—constant pressure setups. For long-term cycling stability test at different stack pressures, the fixed gap setup was used for 75 MPa, and the constant pressure setup was used for 2 MPa. Note that the constant pressure setup could not be used for 75 MPa due to the lack of suitable springs to sustain such high pressure. The cells were cycled at 0.1 C (20 mA g-1) at 23° C.

FIG. 31 shows Coulombic efficiencies of long-term cycling test, including: (a) Co-rolled film at 75 MPa, (b) freestanding films at 75 MPa, (c) co-rolled film at 2 MPa, and (d) freestanding films at 2 MPa. The average Coulombic efficiencies were all over 99.9% for 500 cycles.

FIG. 32 shows specific energy and energy density measurement of an ASSB pouch cell. The cell assembled with co-rolled film and Si was cycled at 0.05 C (10 mA g-1). The stack-level (including positive electrode, SSE, negative electrode, and Al and Cu current collectors) specific energy and energy density are calculated to be 310 Wh kg-1 and 805 Wh L-1, respectively.

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed. Unless defined otherwise, all the technical and scientific terms used herein have the same meanings as commonly known by a person skilled in the art. In the case that there is a plurality of definitions for the terms herein, the definitions provided herein will prevail.

Unless specified otherwise, all the percentages, portions and ratios in the present disclosure are on weight basis.

Unless indicated to the contrary, the numerical parameters set forth in the following specification and attached claims are approximations that may vary depending upon the desired properties sought to be obtained according to aspects of the disclosure. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

While compositions and methods are described herein in terms of “comprising” various components or steps, the compositions and methods can also “consist essentially of” or “consist of” the various components and steps. The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure. The terms “about” and “approximate”, when used along with a numerical variable, generally means the value of the variable and all the values of the variable within an experimental error (e.g., 95% confidence interval for the mean) or within a specified value ±10% or within a broader range. Unless otherwise indicated, all numbers expressing quantities of ingredients, properties such as molecular weight, reaction conditions, and so forth used in the present specification and associated claims are to be understood may be modified by the term “about.”

“A and/or B” when used in this specification, specifies “either A or B or both.”

As used herein, the term “average particle size” means average obtained particle size as observed using scanning electron microscopy (SEM).

As used herein, the term “mean particle size” means mean particle size as observed using SEM.

### <All-Solid-State Battery>

An aspect of the present disclosure relates to a solid-state battery comprising a solid electrolyte material as an electrolyte. Specific examples of the solid-state battery include any type of primary battery, secondary battery, fuel cell, solar cell or capacitor such as a super capacitor. In particular, the battery is a lithium-ion secondary battery. Aspects of the disclosure here may be implemented in a secondary battery with various form factors or battery formats, including for example in a pouch-type battery, a cylindrical battery, or a prismatic battery.

In some aspects, the negative electrode may comprise a negative electrode current collector and a negative electrode active material layer on a surface of the negative electrode current collector facing the first solid electrolyte layer. The negative electrode active material layer may be disposed on or present as a coating layer on at least one side of the negative electrode current collector. The battery may further comprise a separator between the negative electrode and the positive electrode. The separator may be a separate layer or the solid electrolyte layer may function as both a separator and electrolyte.

One aspect of the present disclosure relates to an all-solid-state battery comprising a negative electrode, a positive electrode, and a solid electrolyte layer between the negative electrode and the positive electrode. In this aspect, the negative electrode may comprise a negative electrode active material layer without a current collector. That is, the negative electrode active material layer may function as the negative electrode without the current collector. The negative electrode may consist of only the negative electrode active material layer. The negative electrode may exclude an independent current collector.

An all-solid-state battery according to aspects may endure charging and discharging cycles up to a current density as high as 1.0 mA/cm², 2.0 mA/cm², 2.5 mA/cm², 3.0 mA/cm², 4.0 mA/cm², 5.0 mA/cm², or even 10.0 mA/cm².

An all-solid-state battery according to aspects may have a coulombic efficiency of 50%, 60%, 70%, 80%, 85%, 90%, 95%, 96%, 97%, 98%, 99%, 99.9%, or 99.99% or more, after 10, 100, 500, 1,000, 1,500, 1,600, 1,700, 1,800, 1,900, 2,000, 2,100, 2,200, 2,300, 2,400, 2,500, 3,000, 3,500, 4,000, 4,500, or 5,000 or more charge cycles.

The ASSB may be used in various applications, including small household power storage devices, motorcycles, electric vehicles, hybrid electric vehicles, cell phones, laptops, portable devices, etc.

### <Anode>

The term anode is used interchangeably with the term negative electrode.

The negative electrode current collector is not particularly limited as long as it is conductive without causing any chemical change in the all-solid-state battery, and for example, copper, stainless steel, aluminum nickel, titanium, sintered carbon, copper or stainless steel whose surface is treated with carbon, nickel, titanium, silver or the like, or aluminum-cadmium alloy, etc. can be used. Additionally, as with the positive electrode current collector, the negative electrode current collector may include various forms such as a film, a sheet, a foil, a net, a porous body, a foam, and a nonwoven fabric having minute irregularities formed on their surfaces.

The anode comprises an anode material comprising a product of (i) a lithium (Li) powder, and (ii) a metal selected from aluminum (Al), tin (Sn) or mixture thereof, where the product is a prelithiated metal alloy having a chemical formula of LixMy, wherein Li is lithium, M is the metal, and x and y are integers greater than 0.

In certain aspects, a mass ratio of the lithium to the metal is from 1:4 to 1:20; and wherein the anode is free of a binder material. In some aspects, a mass ratio of the lithium to the metal is from 1:4 to 1:15, the mass ratio of the lithium to the metal is from 1:4 to 1:10, the mass ratio of the lithium to the metal is from 1:4 to 1:7.5, or the mass ratio of the lithium to the metal is from 1:4 to 1:5.

In some aspects, the product is a prelithiated metal further comprising an additional metal selected from Al, Cu, Zn, Ga, In, Ag or mixtures thereof. For example, in some aspects, the additional metal is contained in an amount from 2.5 to 5% by weight.

Some aspects relate to where the product is a prelithiated metal having a chemical formula of Li_{0.25}Al, Li_{0.5}Al, or Li_{0.75}Al.

Some aspects relate to where the product is a prelithiated metal having a chemical formula of Li_{0.25}Sn, Li_{0.5}Sn, or Li_{0.75}Sn.

In some aspects, the lithium powder has an average particle size of 0.1 μm to 50 μm, from 1 μm to 50 μm, from 5 μm to 50 μm, from 10 μm to 50 μm, or from 20 μm to 50 μm.

In some aspects, an N/P ratio is from 1.00 to 2.00, the N/P ratio is from 1.25 to 1.75, from 1.01 to 1.10, from 1.05 to 1.10 or 1.01 to 1.05.

### <Negative Electrode Active Material Layer>

The negative electrode active material may fur her comprise a lithium metal, a lithium alloy, a lithium metal composite oxide, a lithium-containing titanium composite oxide (LTO), and a combination thereof. In this case, the lithium alloy may be an alloy of lithium and at least one metal selected from Na. K, Rb, Cs, Fr, Be, Mg, Ca, Sr. Ba, Ra, Al and Sn. Also, the lithium metal composite oxide; may be lithium and an oxide (MeOₓ) of any one metal (Me) selected from the group consisting of Si, Sn, Zn, Mg, Cd, Ce, Ni and Fe and for example, may be LixFe₂O₃ (0≤x≤1) or LixWO₂ (0≤x≤1).

In addition, the negative electrode active material may comprise metal composite oxides such as SnₓMe₁₋ₓMe′_{y} O_{z} (Me: Mn, Fe, Pb, Ge; Me′: Al, B, P, Si, elements of groups 1, 2 and 3 of the periodic table, halogen; 0<x=1; 1=y=³: 1=z=8); oxides such as SnO, SnO₂, PbO, PbO₂, Pb₂O₃, Pb₃O₃, Sb₂O₃, Sb₂O₄, Sb₂O, GeO, GeO₂, Bi₂O₃, BiO₄ and Bi₂O₅, and carbon-containing negative electrode active materials such as crystalline carbon, amorphous carbon or carbon composite may be used alone or in combination of two or more.

According to some aspects, the negative electrode active material layer may include a metal alloy material. The metal alloy material may include any one or more metals selected from the group consisting of indium (In), lead (Pb), zinc (Zn), tin (Sn), antimony (Sb), bismuth (Bi), cadmium (Cd), gallium (Ga), and titanium (Ti).

In aspects, the metal alloy material may be a binary metal alloy. The binary metal alloy may include a metal alloy comprising Sn and Bi. In some aspects, the binary metal alloy may comprise Bi and Sn.

The binary metal alloy may comprise a compound having the general formula SnₐBi_{b}. In the general formula, “a” and “b” may each be in a range of 0.001-0.999. In the general formula, “a” may be in a range of 0.2 to 0.95, 0.4 to 0.9, 0.5 to 0.85, 0.6 to 0.8, or 0.7 to 0.75. In the general formula, “b” may be in a range of 0.05 to 0.8, 0.1 to 0.65, 0.15 to 0.5, 0.2 to 0.40, or 0.25 to 0.30.

In some aspects, the general formula may include 0.40≤a≤0.95 and 0.05≤b≤0.60. In other aspects, the general formula may include 0.50≤a≤0.90 and 0.10≤b≤0.50. In other aspects, the general formula may include 0.50≤a≤0.90 and 0.10≤b≤0.50. In other aspects, the general formula may include 0.75≤a≤0.85 and 0.15≤b≤0.25. In some aspects, the binary metal alloy includes Sn_{0.85}Bi_{0.15}.

In some aspects, the binary metal alloy may also include inevitable impurities. The binary metal alloy may consist only of Sn and Bi.

In some aspects, the negative electrode active material layer may include inevitable known additives in addition to the binary metal alloy. The negative electrode active material layer may also consist of only the binary metal alloy.

The binary metal alloy may have a melting point in a range of 0° C. to 500° C., 0° C. to 300° C., 1° C. to 225° C., 10° C. to 200° C., 30° C. to 180° C., 50° C. to 170° C., 60° C. to 150° C., 75° C. to 125° C., 85° C. to 125° C., 90° C. to 110° C., or 95° C. to 100° C. In some aspects, the melting point may be in a range of 50° C. to 200° C. Controlling the melting of the binary metal alloy in the negative electrode active material layer to be within the above ranges allows for improved cycling characteristics. In some other aspects, the melting point may be controlled to suit compatibility and thermal stability within metal alloy compositions.

In some aspects, the negative electrode active material layer may have a thickness in a range of 1 nm to 10 mm, 100 nm to 500 μm, 200 nm to 200 μm, 500 nm to 100 μm, 1 μm to 100 μm, 1 μm to 50 μm, 5 μm to 25 μm, or 10 μm to 20 μm. In some aspects, the thickness may be in a range of 1 nm to 100 μm. Controlling the thickness of the negative electrode active material layer to be within the above ranges allows for improved rapid charging characteristics.

### <Solid Electrolyte>

Any suitable sulfide-containing electrolyte material may be used for the solid electrolyte. As used herein, “sulfide-containing electrolyte” refers to an electrolyte that includes inorganic materials containing S which conduct ions (e.g., Li⁺ and Na⁺), and which are suitable for electrically insulating the positive and negative electrodes of an electrochemical cell. Exemplary sulfide-containing electrolytes are set forth in Shaojie Chen et al., “Sulfide solid electrolytes for all-solid-state lithium batteries: Structure, conductivity, stability and application,” Energy Storage Materials, Volume 14, Pages 58-74 (September 2018), which is hereby expressly incorporated by reference in its entirety.

For example, many sulfide-containing electrolyte materials are particularly attractive due to their superionic conductivities (as high as ˜10⁻² S cm⁻¹) and deformability. In particular, Li₃P₇S₁₁, Li₁₀GeP₂S₁₂, and Na₃PS₄ and Li₆PS₅Cl have been reported to exhibit high ionic conductivities; some even close to those of liquid electrolytes. According to aspects of the disclosure, the sulfide solid electrolyte materials also provide a low Young's modulus, which is beneficial for producing favorable interface contacts with electrode materials by simple cold pressing at room temperature.

The sulfide-containing solid electrolyte, according to aspects of the disclosure, may contain sulfur (S) and have the ionic conductivity of metal belonging to Group I or II in the periodic table, e.g., Li⁺ and Na⁺. Additionally, in an aspect of the present disclosure, the selected solid electrolyte has the ionic conductivity of 1×10⁻⁵ S/cm, or according to some aspects of the disclosure, 1×10⁻³ S/cm or more.

Non-limiting examples of the sulfide-containing solid electrolyte may include Li—P—S-based glass, Li—P—S-based glass ceramic and argyrodite-based sulfide-containing solid electrolyte.

Non-limiting examples of the sulfide-containing solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li₆PS₅X (X=at least one of Cl, Br or I).

In an aspect of the present disclosure, the sulfide-containing solid electrolyte may comprise at least one selected from LPS-based glass or glass ceramic such as xLi₂S-yP₂S₅, or an argyrodite-based sulfide-containing solid electrolyte (Li₆PS₅X; X=Cl, Br, I).

In another aspect, the solid electrolyte may include a solid electrolyte commonly used in the all-solid-state battery, such as an inorganic solid electrolyte or an organic solid electrolyte may be used.

In the case of the inorganic solid electrolyte, a ceramic material, a crystalline material or an amorphous material may be used. For instance, inorganic solid electrolytes such as thio-LISICON (Li_{3.25}Ge_{0.25}P_{0.75}S₄), Li₂S—SiS₂, LiI—Li₂S—SiS₂, LiI—Li₂S—P₂S₅, LiI Li₂S P₂O₅, LiI Li₃PO₄ P₂S₅, Li₂S P₂S₅, Li₃PS₄, Li₇P₃S₁₁, Li₂O—B₂O₃, Li₂O—B₂O₃—P₂O₅, Li₂O-V₂O₅ SiO₂, Li₂O—B₂O₃, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}Nw (wherein w is w<1), and Li_{3.6}S_{10.6}P_{0.44} may be used.

The average size of sulfide-based particles is, for example, 0.1 μm to 50 μm, or 0.5 μm to 20 μm, which is within the size range of sulfide-based particles used in well-known all-solid-state batteries. In the case in which the average size of the sulfide-based particles is less than the above range, the sulfide-based particles may form lumps. In the case in which the average size of the sulfide-based particles is greater than the above range, on the other hand, the porosity of the manufactured solid electrolyte is high, whereby the characteristics of the battery may be deteriorated. For example, the capacity of the battery may be reduced.

The sulfide-based particle may have an ion conductivity of 1×10⁻⁴ S/cm or more, or the sulfide-based particle may have an ion conductivity of 1×10⁻³ S/cm or more.

In addition to the above-mentioned sulfide-based solid electrolytes, other well-known solid electrolytes may also be used. For example, an inorganic solid electrolyte, such as Li₂O B₂O₃, Li₂O—B₂O₃—P₂O₅, Li₂O-V₂O₅ SiO₂, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}Nw (w<1), or Li_{3.6}S_{10.6}P_{0.44}, may be used.

In addition, examples of the organic solid electrolyte include organic solid electrolytes prepared by mixing lithium salt to polymeric materials such as polyethylene derivatives, polyethylene oxide derivatives, polypropylene oxide derivatives, phosphate ester polymers, agitation lysine, polyester sulfide, polyvinyl alcohol, and polyvinylidene fluoride. In this case, these may be used alone or in combination of at least one.

In some aspects, the solid electrolyte may be Li₇La₃Zr₂O₁₂ (LLZO) and Li₆PS₅Cl (LPSCl) and LiPON.

A thickness of the solid electrolyte may be in a range of 1 μm to 5 mm, 10 μm to 2 mm, 100 μm to 1 mm, 1 μm to 700 μm, 1 μm to 400 μm, 200 μm to 400 μm, or 300 μm to 400 μm. In some aspects, the thickness may be in a range of 1 μm to 400 μm. An area density of lithium in the first solid electrolyte layer is in a range of 0.01 mg/cm² to 200 mg/cm², 0.1 mg/cm² to 100 mg/cm², 1 mg/cm² to 50 mg/cm², 5 mg/cm² to 30 mg/cm², or 10 mg/cm² to 20 mg/cm².

### <Negative Electrode Current Collector>

The negative electrode current collector is not particularly limited as long as it is conductive without causing any chemical change in the all-solid-state battery, and for example, copper, stainless steel, aluminum, nickel, titanium, sintered carbon, copper or stainless steel whose surface is treated with carbon, nickel, titanium, silver or the like, or aluminum-cadmium alloy, etc., may be used. In some aspects, the negative electrode current collector is copper. Additionally, the negative electrode current collector may include various forms such as a film, a sheet, a foil, a net, a porous body, a foam, and a nonwoven fabric having minute irregularities formed on their surfaces.

### <Positive Electrode>

The positive electrode according to aspects may include any suitable materials so long as the positive electrode is capable of carrying suitable intercalating ions such as, for example, Li⁺, Na⁺ and Va⁺. For purposes of this disclosure, lithium ions will be described. However, it will be understood that the disclosure is not intended to be so limited and that sodium-ions, vanadium-ion, etc. are contemplated in addition or as an alternative to lithium ions.

In the positive electrode, a positive electrode current collector may be used, and is not particularly restricted, as long as the positive electrode current collector exhibits high conductivity while the positive electrode current collector does not induce any chemical change in the battery to which the positive electrode current collector is applied. For example, the positive electrode current collector may be made of stainless steel, aluminum, nickel, titanium, or plastic carbon. Alternatively, the positive electrode current collector may be made of aluminum or stainless steel, the surface of which is treated with carbon, nickel, titanium, or silver.

The positive electrode current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

A positive electrode active material includes an excellent positive electrode active material particle for sulfide-based all-solid-state batteries, the surface of which is reformed, according to the present disclosure. In addition, an additional material may be used depending on what a lithium secondary battery is used for. For example, a transition-metal-compound-based active material or a sulfide-based active material may be used.

Some aspects relate to wherein the cathode positive electrode further comprises a positive electrode material, a solid electrolyte and a conductive agent. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co_{1-x-y}O₂. In some aspects, the positive electrode material comprises at least one of LiCoO₂, LiMn₂O₄, LiMnO₂, or LiNiO₂. In some aspects, the positive electrode material comprises sulfur.

In some aspects of the present disclosure, the positive electrode active material may comprise at least one of lithium cobalt oxide (LiCoO₂), lithium nickel oxide (LiNiO₂), lithium manganese oxide of Formula Li₁₊ₓMn₂₋ₓO₄ (x is 0 to 0.33, for example LiMn₂O₄), LiMnO₃, LiMn₂O₃, LiMnO₂, lithium copper oxide (Li₂CuO₂); vanadium oxide such as LiV₃O₈, LiV₂O₄, V₂O₅, Cu₂V₂O₇, Ni-site lithium nickel oxide represented by Formula LiNi₁₋ₓMₓO₂(M=Co, Mn, Al, Cu, Fe, Mg, B or Ga, 0<x<1), for example, LiNi_{1-z}(Co,Mn,Al)_{z}O₂ (0<z<1); lithium manganese composite oxide represented by Formula LiMn₂₋ₓMₓO₄ (M=Co, Ni, Fe, Cr, Zn or Ta, x=0.01˜1, for example, LiMn_{1.5}Ni_{0.5}O₄ or Li₂Mn₃MO₈ (M=Fe, Co, Ni, Cu or Zn); LiMn₂O₄ with partial substitution of alkali earth metal ion for Li in Formula; disulfide compounds; Fe₂(MoO₄)₃, or lithium iron phosphate (LiFePO₄). In some aspects of the present disclosure, the lithium iron phosphate may have all or at least part of the of the active material particle surface coated with a carbon material to improve conductivity.

According to aspects of the disclosure, the positive electrode active material may comprise at least one selected from Lithium Nickel Cobalt Manganese Oxide (for example, Li(Ni,Co,Mn)O₂, LiNi_{1-z}(Co,Mn,Al)_{z}O₂ (0<z<1)), Lithium Iron Phosphate (for example, LiFePO4/C), Lithium Nickel Manganese Spinel (for example, LiNi_{0.5}Mn_{1.5}O₄), Lithium Nickel Cobalt Aluminum Oxide (for example, Li(Ni,Co,Al)O₂), Lithium Manganese Oxide (for example, LiMn₂O₄) and Lithium Cobalt Oxide (for example, LiCoO₂).

According to some aspects of the present disclosure, the positive electrode active material may comprise lithium transition metal composite oxide, and the transition metal may comprise at least one of Co, Mn Ni or Al.

In some aspects of the present disclosure, the lithium transition metal composite oxide may comprise at least one of compounds represented by the following formula 1.

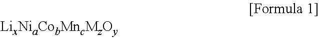

In the above Formula 1, 0≤x≤1.5 0≤a≤, 0b≤1, 0≤c<1, 0≤z<1, 1.5<y<5, a+b+c+z is 1 or less, and M may comprise at least one selected from Al, Cu, Fe, Mg and B.

In some aspects of the present disclosure, the positive electrode active material includes a positive electrode active material having high Ni content of a of 0.5 or more, and its specific example may comprise LiNi_{0.5}Co_{0.1}Mn_{0.1}O₂.

In some aspects of the present disclosure, the positive electrode conductive material may comprise, for example, at least one conductive material selected from the group consisting of graphite, carbon black, carbon fibers or metal fibers, metal powder, conductive whiskers, conductive metal oxide, activated carbon or polyphenylene derivatives. More specifically, the positive electrode conductive material may be at least one conductive material selected from the group consisting of natural graphite, artificial graphite, super-p, acetylene black, ketjen black, channel black, furnace black, lamp black, thermal black, denka black, aluminum powder, nickel powder, zinc oxide, potassium titanate and titanium oxide.

The positive electrode current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The positive electrode binder resin may include polymer for electrode commonly used in the technical field. Non-limiting examples of the binder resin may include, but are not limited to, polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose.

In some aspects of the present disclosure, the solid electrolyte included in the positive electrode may comprise at least one selected from a polymer-based solid electrolyte, an oxide-based solid electrolyte and a sulfide-containing solid electrolyte. In some aspects of the present disclosure, the positive electrode active material may comprise the sulfide-containing solid electrolyte described in the solid electrolyte membrane.

In some aspects of the present disclosure, the positive electrode active material is included in the positive electrode in an amount of 50 wt % or more based on 100 wt % of the positive electrode active material layer. Additionally, the solid electrolyte is, according to aspects of the disclosure, included in the positive electrode in an amount of 10 wt % to 40 wt % based on 100 wt % of the positive electrode active material layer.

### <Method of Producing Negative Electrode>

A method of producing a negative electrode 101 for an all-solid-state battery according to aspects is described below. The method comprises selecting the desired constituent metals from the metals described herein for the binary metal alloy. The method may include optimizing the constituent ratios of the desired metals in order to achieve desired characteristics.

The method comprises melting or alloying the constituent metals together and then mixing the constituent metals for a suitable target time period. The target time period may be for a duration in a range of 1 minute to 10 hours, 5 minutes to 10 hours, 10 minutes to 5 hours, 30 minutes to 4 hours, 1 hour to 2 hours, or 1 hour to 1.5 hours. In some aspects, the duration may be in a range of 5 minutes to 10 hours.

The melting or alloying process may include heating, e.g., in a furnace, at any suitable temperature above the melting point of the binary metal alloy to ensure uniform or substantially uniform mixing. The heating temperature may be in a range of 50° C. to 1,000° C., 100° C. to 900° C., 200° C. to 800° C., 300° C. to 700° C., 400° C. to 600° C., 450° C. to 550° C., or 450° C. to 500° C. In some aspects, the heating temperature may be in a range of 50° C. to 1,000° C. Controlling the heating temperature to be within the above ranges allows for optimized mixing which results in improved cycling characteristics.

The method comprises, after sufficient mixing, cooling and solidifying the binary metal alloy. The parameters of the cooling and solidifying according to aspects are not particularly limited and may be performed according to any suitable methods known in the art.

The method comprises, after solidifying the binary metal alloy, calendaring the alloy to achieve a foil having a target thickness and areal loading to form a binary metal alloy negative electrode active material layer. The parameters of the calendaring according to aspects are not particularly limited and may be performed according to any suitable methods known in the art.

In aspects, the negative electrode may be formed with or without laminating multiples foils together. The binary metal alloy electrode may also be formed with or without any additional electrolyte or additive. In some aspects, the negative electrode 101 may be formed without lamination, and without any additional electrolyte or additive.

The negative electrode active material layer may be pressed on the negative electrode current collector to form the negative electrode. The parameters of the pressing according to aspects are not particularly limited and may be performed according to any suitable methods known in the art.

The resulting negative electrode may be a foil-type electrode. The foil-type electrode may be composed the alloyed metals with or without any additional electrolyte or additive. In some aspects, the foil-type electrode may be composed solely of the alloyed metals without any additional electrolyte or additive.

The method of producing a negative electrode according to aspects is substantially the same as the method of producing a negative electrode except that the negative electrode is formed from the negative electrode active material layer without the current collector. In this aspect, when binary metal alloy is applied, a separate current collector is not necessary due to the foil-shaped negative electrode, which makes it easier to improve energy density. Moreover, a solid solution phase is formed between metals at room temperature to reduce resistance to Li ion behavior due to even distribution and contact between active materials.

### <Method of Manufacturing Battery>

In aspects, the all-solid-state battery may be prepared by forming a positive electrode, forming a negative electrode as described herein, and forming a solid electrolyte layer between the negative electrode and the positive electrode. In the step of calendaring the binary metal alloy to form the negative electrode, a negative electrode active material layer may be formed on a surface of a current collector. In the step of calendaring the binary metal alloy to form the negative electrode, a negative electrode active material layer may be formed without a current collector.

In some aspects, the all-solid-state battery may be manufactured through a dry compression process, in which an electrode powder and solid electrolyte powder are manufactured, introduced into a predetermined mold, and pressed, or a slurry coating process, in which a slurry composition including an active material, a solvent, and a binder is manufactured, coated on a current collector, and dried.

In the present disclosure, the method of manufacturing the all-solid-state battery includes the methods of manufacturing the pre-lithiated negative electrode discussed herein. The contacting, placing, disposing, and/or facing steps discussed with respect to these methods may include any suitable methods known in the art. For example, the solid electrolyte may be disposed between the positive electrode and the negative electrode current collector, and then the same is compressed in order to assemble a cell. The assembled cell is mounted in a sheathing member, and then the sheathing member is encapsulated by heating and compression. A laminate case made of aluminum or stainless steel, a cylindrical metal container, or a prismatic metal container may be appropriately used as the sheathing member.

The respective electrode slurry may be coated on the corresponding current collector using a method of placing the electrode slurry on the current collector and uniformly dispersing the electrode slurry with a doctor blade, a die casting method, a comma coating method, or a screen-printing method. Alternatively, the electrode slurry and the current collector may be formed on a separate substrate, and the electrode slurry and the current collector may be joined to each other through pressing or lamination. At this time, the concentration of a slurry solution or the number of coatings may be adjusted in order to adjust the final coating thickness.

The drying process is a process of removing the solvent or moisture from the slurry in order to dry the slurry coated on the metal current collector. The drying process may vary depending on the solvent that is used. For example, the drying process may be performed in a vacuum oven having a temperature of 50° C. to 200° C. For example, drying may be performed using a warm-air drying method, a hot-air drying method, a low-humidity-air drying method, a vacuum drying method, a (far-) infrared drying method, or an electron beam radiation method. The drying time is not particularly restricted. In general, drying is performed within a range of 30 seconds to 24 hours.

After the drying process, a cooling process may be further performed. In the cooling process, slow cooling to room temperature may be performed such that the recrystallized structure of the binder is sufficiently formed.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

### <Batteries Generally>

Batteries according to aspects may include lithium-ion batteries, sodium-ion batteries and/or vanadium-ion batteries, etc. For purposes of this disclosure, lithium-ion batteries will be described. However, it will be understood that the disclosure is not intended to be so limited and that sodium-ions vanadium-ion, etc. are contemplated in addition or as an alternative to lithium ions.

### Lithium-Ion Batteries

A solid-state battery can receive a charge and discharge an electrical load at various times. A solid-state battery includes electrodes, a cathode electrode and an anode electrode, and an electrolyte to allow lithium ions to travel between the electrodes. In contrast to conventional liquid electrolyte batteries, the solid-state battery does not include any flowable liquids. Forming a circuit between the electrodes causes electricity to flow between the electrodes. During charging of the lithium-ion rechargeable battery, lithium ions are emitted from the cathode electrode and are intercalated into an active material of the anode electrode. During charging of the lithium-ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid-state battery comprising a cathode electrode, an anode electrode, and a solid electrolyte layer intermediate the cathode electrode and the anode electrode. In some aspects, the solid electrolyte may function as both an electrolyte and a separator. While listed as exemplary, the solid-state battery does not require all of these components. For example, in some configurations, such as in an anodeless system, the anode electrode may be omitted. Alternatively, according to aspects of the disclosure, the anode electrode may comprise an anode material with a metal carbon composite, such as a silver-carbon blend or composite, where silver particles are complexed between amorphous and/or crystalline carbon particles. While silver is used as exemplary, other metals may be used, including for example, tin, silicon, zinc, or combinations thereof.

The solid-state battery can optionally comprise an additional layer or layers, such as, for example, a separator layer, a protective layer, an inhibitor layer, a solid electrolyte interface layer, or a combination thereof. For example, a protective layer may be incorporated between the electrodes and the solid electrolyte layer. This protective layer may comprise materials such as lithium phosphate, lithium titanate, or lithium lanthanum zirconium oxide (LLZO), which can help prevent undesirable side reactions at the electrode-electrolyte interface. The protective layer may also serve to mitigate dendrite formation, particularly on the anode side, thereby improving the overall cycle life and safety of the battery. A separator layer may also be included in some configurations of the solid-state battery. While traditional liquid electrolyte batteries often use porous polymer separators, solid state batteries may employ thin ceramic or glass-ceramic layers as separators. These separator layers can provide additional mechanical support to the battery structure while still allowing for efficient ion transport. Materials such as LLZO, LATP (lithium aluminum titanium phosphate), or LAGP (lithium aluminum germanium phosphate) may be used for this purpose. The separator layer may also be designed to have a gradient structure, with properties optimized for contact with both the cathode and anode materials.

### Cell Configuration

The solid-state battery may comprise a single cell. In other aspects, the solid-state battery can comprise multiple cells, such as, at least two cells, at least three cells, or at least four cells. Connecting the cells in series increases a voltage of the solid-state battery and connecting the cells in parallel increases an amp-hour capacity of the solid-state battery. In some embodiments, the solid-state battery may be configured with a combination of series and parallel connections to achieve desired voltage and capacity characteristics. For example, multiple cells may be arranged in groups, with cells within each group connected in parallel to increase capacity, and these groups then connected in series to increase voltage. This configuration, sometimes referred to as a series-parallel arrangement, allows for greater flexibility in battery design and can help optimize performance for specific applications. Additionally, the number and arrangement of cells may be adjusted to meet various form factor requirements.

### Thickness of Cell

A thickness, t₁, of the cell can be about 100, 150, 200, 250, 300, 400, 500, 1,000 μm, 2,000 μm, or 5,000 μm. In embodiments, the thickness, t₁, of the cell may be within a range formed by selecting any two numbers listed in the immediately previous sentence, e.g., between about 100 μm and about 5,000 μm or about 100 μm and about 1,000 μm.

### Cathode Electrode Generally

The cathode electrode is associated with one polarity (e.g., positive) of the solid-state battery. The cathode electrode is configured as a positive electrode during discharge of the solid-state battery. The cathode electrode is suitable for lithium ion diffusion between a current collector and the solid electrolyte layer. The cathode electrode is in electrical communication with the current collector. In embodiments, the cathode electrode is formed over and in direct contact with the current collector. In other embodiments, another functional layer may be interposed between the cathode electrode and the current collector.

### Material for the Cathode Electrode

The cathode electrode may be capable of reversible intercalation and deintercalation of lithium ions. For example, the cathode electrode can comprise one or more of a cathode active material (“CAM”), a conductive carbon, a solid electrolyte material, a binder, the like, or combinations thereof. Optionally, the cathode electrode 102 may further comprise an additive, such as, for example, an oxidation stabilizing agent, a reduction stabilizing agent, a flame retardant, a heat stabilizer, an antifogging agent, a thickener, the like, or a combination thereof. Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners.

### Material for the Cathode Active Material

The cathode active material can include lithium cobalt oxide (LiCoO₂), lithium nickel oxide (LiNiO₂), Li[NiₐCobMnₑM¹_{d}]O₂ (wherein M¹ is any one element elected from the group consisting of Al, Ga, In, or a combination thereof, 0.3≤a≤1.0, 0≤b≤0.5, 0≤c≤0.5, 0≤d≤0.1, and a+b+c+d=1), Li(LiₑM²_{f-e-f}M³_{f′})O_{2-g}A_{g} (wherein O≤e≤0.2, 0.6≤f′≤1, 0≤f′0.2, O≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

In addition to the cathode active materials previously mentioned, the cathode electrode may include other types of materials. For example, lithium iron phosphate (LiFePO₄) may be used as a cathode active material due to its excellent thermal stability and long cycle life. Other phosphate-based materials such as lithium manganese iron phosphate (LiMnₓFe₁₋ₓPO₄) or lithium cobalt phosphate (LiCoPO₄) may also be suitable.

The cathode active material may also include layered oxide materials with various compositions, such as Li(Ni_{1-x-y}CoₓMn_{y})O₂ (NCM) or Li(Ni_{1-x-y}CoₓAl_{y})O₂ (NCA), where the ratios of Ni, Co, Mn, and Al can be adjusted to optimize performance characteristics. For instance, NCM materials with high nickel content, such as NCM811 (LiNi_{0.5}Co_{0.1}Mn_{0.1}O₂), may be used to achieve higher energy density. In some cases, the cathode active material may comprise spinel structures like LiNi_{0.5}Mn_{1.5}O₄, which can offer high voltage operation. Alternatively, materials with favorite structures, such as LiFeSO₄F or LiVPO₄F, may be employed for their potential for high energy density and good thermal stability.

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

The cathode active material may also include emerging classes of materials such as disordered rock salt structures (e.g., Li₃NbO₄-based materials) or high-entropy oxides, which may offer unique combinations of high capacity and structural stability. In some cases, the cathode active material may incorporate dopants or substitutional elements to further tune its electrochemical properties.

### Particulate Nature of the Cathode Active Material

The cathode active material can be particle shaped. The cathode active material can comprise a particle size of about 10 nm, 20 nm, 30 nm, 50 nm, 70 nm, 100 nm, 200 nm, 300 nm, 400 nm, 500 nm, 1,000 nm, 10 μm, 20 μm, 30 μm, 50 μm, 70 μm, 100 μm, 200 m, 300 μm, 400 μm, 500 μm, or 1,000 μm. In embodiments, particle size of the cathode active material may be within a range formed by selecting any two numbers listed in the immediately previous sentence, e.g., between about 10 nm and about 1,000 μm. Gaps between cathode active material in the cathode electrode can be filled with the solid electrolyte material.

### Amount of the Cathode Active Material in the Cathode Electrode

The amount of the cathode active material in the solid-state battery affects the charge and discharge capacity of the solid-state battery. In order to manufacture a high-capacity cathode electrode, a high level of cathode active material can be included in the cathode electrode. For example, the cathode electrode includes at, about, or greater than 30, 40, 50, 60, 70, 80, 90, 95, or 98 wt % of cathode active material based on the total weight of the cathode electrode. In embodiments, cathode active material in the cathode electrode may be within a range formed by selecting any two numbers listed in the immediately previous sentence, e.g., between about 40 wt % and about 98 wt %.

### Material for the Conductive Material in the Cathode Electrode

The conductive material in the cathode electrode is not particularly limited, as long as it has conductivity while not causing any chemical change in the corresponding solid-state battery. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive materials, such as polyphenylene derivatives; the like; or combinations thereof. Other conductive materials that may be used in the cathode electrode include graphene and its derivatives, such as reduced graphene oxide (rGO) or graphene nanoplatelets. These two-dimensional carbon materials offer high surface area and excellent electrical conductivity. Conductive polymers, such as polyaniline (PANI), polypyrrole (PPy), or poly(3,4-ethylenedioxythiophene) (PEDOT), may also be employed to enhance the electrode's conductivity while potentially improving its mechanical properties. In some cases, hybrid conductive additives combining different materials, such as CNT-graphene composites or metal-coated carbon materials, may be used to synergistically improve the overall conductivity and performance of the cathode electrode.

### Amount of Conductive Material in the Cathode Electrode

The cathode electrode includes at or about 1, 2, 5, 10, 15, 20, 25, or 30 wt % of conductive material based on the total weight of the cathode electrode. In embodiments, conductive material in the cathode electrode may be within a range formed by selecting any two numbers listed in the immediately previous sentence, e.g., between about 1 wt % and about 30 wt %.

### Material for the Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene):poly(styrene sulfonate) (PEDOT:PSS) or polyaniline (PANI) may be used to simultaneously improve both the mechanical integrity and electrical conductivity of the electrode. Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode includes at or about 1, 2, 5, 10, 15, 20, 25, or 30 wt % of binder based on the total weight of the cathode electrode. In embodiments, binder in the cathode electrode may be within a range formed by selecting any two numbers listed in the immediately previous sentence, e.g., between about 1 wt % and about 30 wt %.

### Material for Solid Electrolyte Material

The solid electrolyte material in the cathode electrode can be individually configured the same as the material for the solid electrolyte layer discussed below. The solid electrolyte material in the cathode electrode can be the same or different than the material for the solid electrolyte layer.

### Amount of Solid Electrolyte Material in Cathode Electrode

The cathode electrode 102 includes about 1, 2, 5, 10, 15, 20, 25, or 30 wt % of solid electrolyte material based on the total weight of the cathode electrode. In embodiments, the amount of solid electrolyte material in the cathode electrode may be within a range formed by selecting any two numbers listed in the immediately previous sentence, e.g., between about 1 wt % and about 30 wt %.

### Thickness of Cathode Electrode

A thickness, t₂, of the cathode electrode can be about 10, 20, 50, 100, 150, 200, 250, 300, 400, 500, or 1,000 km. In embodiments, the thickness, t₂, of the cathode electrode may be within a range formed by selecting any two numbers listed in the immediately previous sentence, e.g., between about 10 μm and about 1,000 km.

### Porosity of Cathode Electrode

A porosity of the cathode electrode can be about 0, 1, 2 3, 4, 5, 6, 7, 8, 9, 10, 11, 12, 13, 14, 15, 16, 17, or 18 vol % based on the total volume of the cathode electrode. In embodiments, the porosity of the cathode electrode may be within a range formed by selecting any two numbers listed in the immediately previous sentence, e.g., between 0 vol % and about 18 vol %.

### Lithium Ion Diffusivity of the Cathode Electrode

The cathode electrode can include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s. In embodiments, the lithium ion diffusivity of the cathode electrode may be within a range formed by selecting any two numbers listed in the immediately previous sentence, e.g., between 1×10⁻¹⁴ cm²/s and about 1×10⁻⁷ cm²/s.

### Current Collector at the Cathode Electrode

The current collector collects electrical energy generated at the cathode electrode and supports the cathode electrode. The material of the current collector is not particularly limited as long as it allows adhesion of the cathode electrode, has a suitable electrical conductivity, and does not cause significant chemical changes in the corresponding solid-state battery in the voltage range of the solid-state battery. For example, the current collector is made of or includes various materials, such as, a metal, a conductive carbon, or a conductive ceramic, although not limited thereto. The metal of the current collector may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Shape and Size of the Current Collector at the Cathode Electrode

It is possible to increase the adhesion of the cathode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. The current collector may also be configured in various other geometries to optimize its performance and integration with the cathode electrode, and may be sized for specific form factors, such as pouch, cylindrical, and/or prismatic form factors. For instance, the current collector may be structured as a mesh or grid, which can provide enhanced mechanical support while maintaining high surface area for electrode adhesion. In some embodiments, the current collector may be designed with a corrugated or wavy pattern, potentially increasing the contact area with the cathode material and improving overall conductivity. The current collector may also be fabricated as a perforated sheet, allowing for better electrolyte penetration and ion transport. In certain cases, the current collector may be formed as a three-dimensional structure, such as an interconnected network of fibers or a honeycomb-like configuration, which could enhance the structural integrity of the electrode assembly while facilitating efficient current collection.

### Thickness of Current Collector at the Cathode Electrode

A thickness, t₃, of the current collector can be about 3, 5, 10, 15, 20, 25, 50, 100, 150, 200, 300, 400, or 500 μm. In embodiments, the thickness, t₃, of the current collector 108 may be within a range formed by selecting any two numbers listed in the immediately previous sentence, e.g., between about 5 μm and about 500 μm.

### Manufacturing Method for the Cathode Electrode

The cathode electrode may be obtained by various methods. For example, the cathode active material can be mixed and agitated with a solvent, and optionally a binder, conductive material, and a dispersing agent to form slurry. Then, the slurry can be applied (e.g., coated) onto the current collector, followed by pressing and drying, to obtain the cathode electrode.

In addition to the slurry-based method described, the cathode electrode may be manufactured using various other techniques. For instance, a dry powder coating process may be employed, where the cathode active material, conductive additives, and binder are mixed in a dry state and then directly applied to the current collector using electrostatic deposition or mechanical compression. This method may reduce environmental impact by eliminating the need for solvents.

In some cases, the cathode electrode may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

Another method for manufacturing the cathode electrode may involve electrospinning. In this process, a solution containing the cathode active material, conductive additives, and a polymer binder is extruded through a nozzle under an electric field, resulting in the formation of nanofibers. These fibers can be collected directly on the current collector to form a highly porous electrode structure with increased surface area.

In some embodiments, the cathode electrode may be prepared using a tape casting method. This technique involves spreading a slurry of electrode materials onto a moving carrier film using a doctor blade, followed by drying and calendering. The resulting electrode tape can then be laminated onto the current collector.

Alternatively, the cathode electrode may be fabricated using a spray coating technique. In this method, a fine mist of the electrode slurry is sprayed onto the current collector using compressed air or ultrasonic atomization. This approach may allow for the creation of thin, uniform electrode layers and can be particularly useful for large-scale production.

In certain cases, the cathode electrode may be manufactured using a freeze-casting method. This process involves freezing a slurry of electrode materials, followed by sublimation of the ice to create a porous structure. The resulting porous electrode can then be sintered and attached to the current collector.

For some applications, the cathode electrode may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Application Methods for the Slurry for the Cathode Electrode

The application of the slurry to the cathode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In some embodiments, the cathode electrode may be fabricated using a double layer slot die coating (DLD) technique. This method involves the simultaneous application of two distinct layers of electrode materials onto the current collector in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for the Slurry for the Cathode Electrode

The solvent for forming the cathode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene. In some aspects of the disclosure, the cathode electrode may be prepared using a solvent-free method, such as dry powder processing or melt extrusion, which eliminates the need for liquid solvents and may offer environmental and cost benefits.

### Dispersing Agent for the Slurry for the Cathode Electrode

The dispersing agent forming the cathode electrode may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for the Cathode Electrode

The slurry for the cathode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode. In addition to the drying techniques mentioned, the cathode electrode may be dried using other methods such as infrared (IR) drying, microwave drying, or freeze-drying. In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode is associated with one polarity (e.g., negative) of the solid-state battery, which is different than the polarity of the cathode electrode. The anode electrode is configured as a negative electrode during discharge of the solid-state battery. The anode electrode is suitable for lithium ion diffusion between a current collector and the solid electrolyte layer. The anode electrode is in electrical communication with the current collector. In embodiments, the anode electrode is formed over and in direct contact with the current collector. In some embodiments, as explained above, the solid-state battery may utilize an anodeless electrode system. In such configurations, the anode electrode may be omitted, and lithium metal may be deposited directly onto the current collector during charging. This approach may potentially increase the energy density of the battery by eliminating the need for a separate anode material, while also potentially reducing the overall thickness of the battery structure.

### Material for the Anode Electrode

The anode electrode may be capable of reversible intercalation and deintercalation of lithium ions. For example, the anode electrode can comprise an anode active material, a binder, the like, or combinations thereof. Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof. Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Material for the Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOx (0<x<2), SnO₂, vanadium oxide or lithium vanadium oxide; and a composite including the metallic compound and the carbon-based material such as a Si—C composite or a Sn—C composite. A lithium metal thin film may be used as the anode active material. The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof. In addition to the materials mentioned, the anode active material may also include titanium-based compounds such as lithium titanate (Li₄Ti₅O₁₂) or titanium dioxide (TiO₂), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode is made of or includes lithium or a lithium alloy, dendrites may form on the anode electrode. The dendrites are a metallic lithium structure formed when extra lithium ions accumulate on a surface of the anode electrode. The formed dendrites may damage the solid electrolyte layer, reduce battery capacity of the solid-state battery, and/or otherwise lead to undesired performance of the solid-state battery. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, it is important to note that while solid electrolytes can significantly reduce the risk of dendrite growth, they may not completely eliminate it, and ongoing research aims to develop advanced solid electrolyte materials with enhanced dendrite suppression capabilities.

### Nature of the Anode Active Material

The anode active material can be particle shaped or it may be a continuous, unitary form (e.g., a thin film or sheet). In embodiments where the anode active material is particle shaped, the anode active material can comprise a particle size of about 10 nm, 20 nm, 30 nm, 50 nm, 70 nm, 100 nm, 200 nm, 300 nm, 400 nm, 500 nm, 1,000 nm, 10 μm, m, 30 μm, 50 μm, 70 μm, 100 μm, 200 μm, 300 μm, 400 μm, 500, or 1,000 μm. In embodiments, particle size of the anode active material may be within a range formed by selecting any two numbers listed in the immediately previous sentence, e.g., between about 10 nm and about 1,000 μm.

### Amount of Anode Active Material in the Anode Electrode

The amount of the anode active material in the solid-state battery affects the charge and discharge capacity of the solid-state battery. In order to manufacture a high-capacity anode electrode, a high level of anode active material can be included in the anode electrode. For example, the anode electrode includes at, about, or greater than 70, 80, 90, 95, 98, 99, or 100 wt % of anode active material based on the total weight of the anode electrode. In embodiments, anode active material in the anode electrode may be within a range formed by selecting any two numbers listed in the immediately previous sentence, e.g., between about 70 wt % and about 100 wt %.

### Material for Binder in the Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in the Anode Electrode

The anode electrode can include at or about 0, 1, 2, 5, 10, 15, 20, 25, or 30 wt % of binder based on the total weight of the anode electrode. In embodiments, binder in the anode electrode may be within a range formed by selecting any two numbers listed in the immediately previous sentence, e.g., between about 0 wt % and about 30 wt %.

### Thickness of the Anode Electrode

The anode electrode can be about 10, 20, 30 50, 60, 70, or 100 μm thick. In embodiments, the thickness, t₄, of the anode electrode 104 may be within a range formed by selecting any two numbers listed in the immediately previous sentence, e.g., between about m and about 100 μm or about 10 μm and about 20 μm.

### Porosity of Anode Electrode

A porosity of the anode electrode can be about 0, 1, 2 3, 4, 5, 6, 7, 8, 9, 10, 11, 12, 13, 14, 15, 16, 17, or 18 vol % based on the total volume of the anode electrode. In embodiments, the porosity of the anode electrode may be within a range formed by selecting any two numbers listed in the immediately previous sentence, e.g., between 0 vol % and about 18 vol %.

### Lithium Ion Diffusivity of the Anode Electrode

The anode electrode can include a lithium ion diffusivity of about 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s. In embodiments, the lithium ion diffusivity of the anode electrode may be within a range formed by selecting any two numbers listed in the immediately previous sentence, e.g., between 1×10⁻¹⁴ cm²/s and about 1×10⁻⁷ cm²/s.

### Current Collector at the Anode Electrode

The current collector collects electrical energy generated at the anode electrode 104 and supports the anode electrode. The material of the current collector is not particularly limited as long as it allows adhesion of the anode electrode, has a suitable electrical conductivity, and does not cause significant chemical changes in the corresponding solid-state battery in the voltage range of the solid-state battery. For example, the current collector is made of or includes a metal or a conductive carbon, although not limited thereto. The metal of the current collector may include one or more selected from the group consisting of aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape and Size of the Current Collector at the Anode Electrode

It is possible to increase the adhesion of the anode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. In addition to the shapes mentioned, the current collector may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector. Furthermore, the current collector may be designed to accommodate different form factors of solid-state batteries, such as pouch cells, cylindrical cells, or prismatic cells, each offering unique advantages in terms of packaging efficiency, thermal management, and overall battery performance.

### Thickness of Current Collector at the Anode Electrode

A thickness, t₃, of the current collector can be about 3, 5, 10, 15, 20, 25, 50, 100, 150, 200, 300, 400, or 500 μm. In embodiments, the thickness, t₃, of the current collector may be within a range formed by selecting any two numbers listed in the immediately previous sentence, e.g., between about 5 μm and about 500 μm.

### Manufacturing Method for the Anode Electrode

The anode electrode may be obtained by various methods, such as, for example, atomic deposition, extrusion, rolling, a slurry method, or a combination thereof. For example, the anode active material can be mixed and agitated with a solvent, and optionally a binder, and a dispersing agent to form slurry. Then, the slurry can be applied (e.g., coated) onto the current collector, followed by pressing and drying, to obtain the anode electrode. In addition to the methods mentioned, the anode electrode may be manufactured using various other techniques, including dry electrode processes. These alternative methods may offer advantages in terms of environmental impact, cost-effectiveness, and scalability.

Dry powder coating may be employed as an alternative to the slurry method. In this process, the anode active material, conductive additives, and binder are mixed in a dry state and then directly applied to the current collector using electrostatic deposition or mechanical compression. This method eliminates the need for solvents, potentially reducing environmental impact and processing time.

Additive manufacturing techniques, such as 3D printing, may be used to fabricate the anode electrode. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

Electrospinning is another potential method for manufacturing the anode electrode. In this process, a solution containing the anode active material, conductive additives, and a polymer binder is extruded through a nozzle under an electric field, resulting in the formation of nanofibers. These fibers can be collected directly on the current collector to form a highly porous electrode structure with increased surface area.

Tape casting may be employed to prepare the anode electrode. This technique involves spreading a slurry of electrode materials onto a moving carrier film using a doctor blade, followed by drying and calendaring. The resulting electrode tape can then be laminated onto the current collector.

Spray coating techniques may be used to fabricate the anode electrode. A fine mist of the electrode slurry is sprayed onto the current collector using compressed air or ultrasonic atomization. This approach may allow for the creation of thin, uniform electrode layers and can be particularly useful for large-scale production.

Freeze-casting is another potential method for manufacturing the anode electrode. This process involves freezing a slurry of electrode materials, followed by sublimation of the ice to create a porous structure. The resulting porous electrode can then be sintered and attached to the current collector.

In some cases, a sol-gel process may be used to prepare the anode electrode. This method involves the formation of a colloidal suspension (sol) that is then converted into a gel-like network containing the anode active material and other components. The gel can be applied to the current collector and subsequently heat-treated to form the final electrode structure.

For certain applications, physical vapor deposition (PVD) or chemical vapor deposition (CVD) techniques may be employed to create thin film anodes directly on the current collector. These methods can produce highly uniform and dense electrode layers, which may be particularly beneficial for certain types of solid-state batteries.

Lastly, mechanical alloying and high-energy ball milling may be used to prepare composite anode materials, which can then be pressed into electrodes or applied to the current collector using one of the aforementioned methods. This technique can be particularly useful for creating nanostructured or amorphous anode materials with enhanced electrochemical properties.

### Ball Milling Generally

Ball milling is a valuable technique for mixing and preparing materials for solid-state batteries. Ball milling is a mechanical technique widely used to grind powders into fine particles and mix materials in various applications, including the preparation of solid-state battery components. In the context of solid-state batteries, ball milling is often employed to mix and blend the electrode materials, solid electrolytes, and other components. Exemplary ball milling devices may include planetary ball mills, attritor mills, and vibratory ball mills. These devices typically consist of a rotating or vibrating chamber containing grinding balls made of materials such as steel, ceramic, or zirconia.

### Homogeneous Mixing

Ball milling is effective in achieving a homogeneous mixture of different powders. This is crucial for ensuring uniform distribution of components in the electrode materials and solid electrolytes, which, in turn, impacts the overall performance of the battery.

### Reducing Particle Size

Ball milling can reduce the particle size of the materials involved, leading to increased surface area and improved reactivity. Smaller particle sizes can enhance the kinetics of electrochemical reactions, contributing to better battery performance.

### Enhanced Electrode-Electrolyte Interface

Ball milling can facilitate the formation of a well-defined interface between the electrode and solid electrolyte. This is important for promoting efficient ion transport and minimizing interfacial resistance within the solid-state battery.

### Promoting Solid-State Reactions

Ball milling can induce solid-state reactions between different components, promoting the formation of desired phases and structures in the materials. This is particularly relevant for the synthesis of composite electrode materials or preparation of the composite electrolyte materials provided herein.

### Optimizing Conductivity

Ball milling can be used to optimize the conductivity of electrode materials by ensuring a good distribution of conductive additives, such as carbon or metal nanoparticles, within the composite; or the additive materials, within the solid electrolyte, as provided herein.

### Controlling Morphology

The milling process can also influence the morphology of the materials, including particle shape and size distribution. Controlling these aspects is important for achieving the desired electrochemical properties and overall performance of the solid-state battery.

### Energy Considerations

Ball milling is an energy-intensive process, and the duration and speed of milling need to be carefully controlled to avoid excessive heating, which could lead to undesired reactions or damage to the materials.

### Application Methods for Slurry for Anode Electrode

The application of the slurry for the anode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating. Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for the Slurry for the Anode Electrode

The solvent for forming the anode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene. In some embodiments, the anode electrode may be prepared using a solvent-free method, such as dry powder processing or melt extrusion, which eliminates the need for liquid solvents and may offer environmental and cost benefits.

### Dispersing Agent for Slurry for the Anode Electrode

The dispersing agent forming the anode electrode may include an aqueous dispersing agent and/or an organic dispersing agent, such as, for example, N-methyl-2-pyrrolidone. The dispersing agent forming the anode electrode may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers. In some embodiments, the anode electrode 104 may be prepared using methods that do not require a dispersing agent, such as dry powder processing or certain additive manufacturing techniques.

### Drying Technique for the Anode Electrode

The slurry for the anode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104. In addition to the drying techniques mentioned, several other methods may be employed to dry the anode electrode slurry. These additional techniques can offer various advantages depending on the specific materials, production requirements, and desired electrode properties.

Infrared (IR) drying may be used to rapidly heat the electrode surface, promoting efficient solvent evaporation. This method can be particularly effective for thin electrode coatings and may allow for precise control of the drying process. Microwave drying is another option that can provide volumetric heating of the electrode material, potentially leading to more uniform drying throughout the electrode thickness. In some cases, a combination of convection and microwave drying may be employed to optimize both drying speed and uniformity.

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

In some cases, a two-step drying process may be employed. For example, initial drying may be performed at a lower temperature to remove bulk solvent, followed by a higher temperature step to remove residual solvent and potentially initiate any desired chemical reactions within the electrode material.

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer is suitable for lithium ion diffusion between the cathode electrode and the anode electrode. The solid electrolyte layer provides an electrically conductive pathway for the movement of charge carriers between the cathode electrode and the anode electrode. The solid electrolyte layer is in electrical communication with the cathode electrode and the anode electrode. In embodiments, the solid electrolyte layer is formed over and in direct contact with the cathode electrode or the anode electrode. In embodiments, the solid electrolyte layer is in direct contact with the cathode electrode and the anode electrode. In other embodiments, another functional layer may be interposed between the solid electrolyte layer and the cathode electrode and/or the anode electrode.

The solid electrolyte layer may have a gradient structure, with composition or properties that vary across its thickness to optimize ion transport and interfacial compatibility. For example, the layer could have higher ionic conductivity near the electrodes and higher mechanical strength in the middle.

In some embodiments, the solid electrolyte layer may be formed as a composite, incorporating both ceramic and polymer components to balance mechanical properties and ion conductivity. The ceramic component could provide structural stability while the polymer enhances flexibility and electrode contact.

The solid electrolyte layer may include engineered porosity or channels to facilitate ion transport while maintaining mechanical integrity. These could be created through techniques like freeze-casting or templating.

In certain configurations, the solid electrolyte layer may be applied as multiple thin sublayers with slightly different compositions or properties, allowing for fine-tuning of the overall layer characteristics.

The interface between the solid electrolyte and electrodes may be modified through surface treatments or the addition of buffer layers to improve adhesion and reduce interfacial resistance. This could involve plasma treatment, chemical modification, or deposition of nanoscale interface layers.

In some embodiments, the solid electrolyte layer may incorporate self-healing properties, such as the inclusion of microcapsules containing electrolyte material that can repair small cracks or defects that form during cycling.

The solid electrolyte layer may be designed with anisotropic properties, having different ionic conductivities in different directions to optimize ion transport between electrodes while minimizing unwanted side reactions.

In certain configurations, the solid electrolyte layer may include embedded current collectors or conductive networks to enhance charge transport and distribution across the battery structure.

The solid electrolyte layer may be formulated to have temperature-dependent properties, optimizing performance across a wide range of operating conditions. This could involve phase-change materials or components with different thermal expansion coefficients.

In some embodiments, the solid electrolyte layer may be designed to be pressure-sensitive, with ionic conductivity that improves under moderate compression to enhance performance during battery operation.

### Material for Solid Electrolyte Layer

The solid electrolyte layer may be capable of transport of lithium ions. The material of the solid electrolyte layer is not particularly limited as long as it allows adhesion with adjacent layers, has a suitable electrical conductivity, and does not cause significant chemical changes in the corresponding solid-state battery in the voltage range of the solid-state battery. For example, besides the composite solid electrolyte materials including the additive material and the sulfide containing solid electrolyte material provided herein, the solid electrolyte layer may include various inorganic solid electrolytes, polymer solid electrolytes, polymer gel electrolytes, although not limited thereto. Additionally, or alternatively, the solid electrolyte layer may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li₃Ocl and Li₃Obr, lithium nitride (Li₃N), and lithium borohydride (LiBH₄) have been investigated as potential solid electrolyte materials for lithium-ion batteries.

### Sulfide Based Solid Electrolyte

As provided herein, the sulfide-based solid electrolyte includes sulfur (S) and has ionic conductivity of metal belonging to Group I or Group II of the periodic table, and may include Li—P—S-based glass or Li—P—S-based glass ceramics. For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.1}66S₄, Li₄SnS₄, Li_{3.25}Ge_{0.25}P_{0.75}S₄, Li₂S P₂So, B₂S₃—Li₂S, Xli₂S-(100-x)P₂S₅(x=70-80), Li₂S—SiS₂—Li₃N, Li₂S—P₂S₅—LiI, Li₂S—SiS₂—LiI, Li₂S B₂S₃—LiI, Li₃N, LISICON, UPON (Li_{3+y}PO₄₋ₓNₓ), thio-LISICON (Li_{3.25}Ge_{0.25}P_{0.75}S₄), Li₂O—Al₂O₃—TiO₂-P₂O₅(LATP), Li₂S—P₂S₅, Li₂S—LiI—P₂S₅, Li₂S—LiI-Li₂O—P₂S₅, Li₂S—LiBr—P₂S₅, Li₂S—Li₂O—P₂S₅, Li₂S—Li₃PO₄—P₂S₅, Li₂S—P₂S₅P₂O₅, Li₂S—P₂S₅SiS₂, Li₂S—P₂S₅SnS, Li₂S—P₂S₅Al₂S₃, Li₂S—GeS₂, Li₂S—GeS₂—ZnS, Li₁₀GeP₂S₁₂ (LGPS), Li₇P₃S₁₁, Li₆PS₅Cl, Li₆PS₅Br, Li₆PS₅I, Li₉0.5₄S_{11.74}P_{1.44}S_{11.7}Cl_{0.3}, Li₁₁S₁₂PS₁₂, the like, or combinations thereof. In some cases, doped variants of these materials, such as Al-doped Li₁₀GeP₂S₁₂ or Sb-doped Li₆PS₅Cl, may also be employed to further enhance ionic conductivity or stability.

### Oxide-Based Solid Electrolyte

The oxide-based solid electrolyte material contains oxygen (O) and has ionic conductivity of metal belonging to Group I or II of the periodic table. The oxide-based solid electrolyte material may include at least one selected from the group consisting of LLTO-based compounds, Li₆La₂CaTa₂O₁₂, Li₆La₂Anb₂O₁₂ (A is Ca or Sr), Li₂Nd₃TeSbO₁₂, Li₃BO₂O_{2.5}N_{0.5}, Li₉SiA₁O₈, LAGP-based compounds, LATP-based compounds, Li₁₊ₓTi₂₋ₓAlₓS_{1y}(PO₄)_{3-y} (0≤x≤1, 0≤y≤1), LiAlₓZr₂₋ₓ (PO₄)₃ (0≤x≤1, 0≤y≤1), LiTiₓZr₂₋ₓ(PO₄)₃(0≤x≤1, 0≤y≤1), LISICON-based compounds, LIPON-based compounds, perovskite-based compounds, NASICON-based compounds and LLZO-based or derived compounds (such as Al-doped Li₇La₃Zr₂O₁₂ and Ta-doped Li₇La₃Zr₂O₁₂). Lithium-rich anti-perovskites like Li₃Ocl and Li₃Obr have also been investigated as potential oxide-based solid electrolytes. In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyalginate lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof. The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof. Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of at least one selected from the group consisting of F⁻, Cl⁻, Br⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH, CF₃(CF₂)₇₅O₃⁻, CF₃CO₂—, CH₃CO₂⁻, SCN⁻, (CF₃CF₂SO₂)₂N⁻, and the like. For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF6, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂).2NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 50, 60, 70, 80, 100, 200, 300, or 400 parts of electrolyte salt, if present, based on the total weight of the solid electrolyte layer. In embodiments, electrolyte salt in the solid electrolyte layer may be within a range formed by selecting any two numbers listed in the immediately previous sentence, e.g., between about 0 parts and about 400 parts, or about 60 parts and 400 parts based on the total weight of the solid electrolyte layer.

### Ion Conductivity of the Solid Electrolyte Layer

The solid electrolyte layer can include a suitable reduction stability and/or ion conductivity. Since the solid electrolyte layer mainly functions to transport lithium ions between electrodes, the solid electrolyte layer can include a desirable ion conductivity of at, about, or greater than, 10⁻⁷ S/cm, 10⁻⁶ S/cm, 10⁻⁵/cm, or 10⁻⁴ S/cm.

### Thickness of the Solid Electrolyte Layer

A thickness, t₆, of the solid electrolyte layer can be about 3, 5, 10, 15, 20, 25, 30, 50, 70, 100, 150, 200, 300, 400, 500, or 1,000 μm. In embodiments, the thickness, tU, of the solid electrolyte layer may be within a range formed by selecting any two numbers listed in the immediately previous sentence, e.g., between about 5 μm and about 1,000 μm, about 30 μm and about 100 μm, or about 30 μm and about 50 μm.

### Unfinished Product

The cell can be provided as an unfinished product. In embodiments, the cell is stored, transported, and/or delivered to a reseller, customer, or the like that finishes manufacture of a battery assembly or product comprising the cell. In other embodiments, the cell is a finished battery assembly or product.

### Seal the Battery

An enclosure of the solid-state battery can be sealed to finish making the solid-state battery such that it will work as a battery. The sealing process may involve various techniques to ensure the internal components are protected from external environmental factors and to maintain the integrity of the battery structure. For example, the enclosure may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation. Once properly sealed, the solid-state battery is ready for final quality control checks, which may include electrical testing, leak detection, and visual inspections. After passing these checks, the solid-state battery could be packaged and sold as a finished product, ready for integration into various electronic devices, electric vehicles, energy storage systems, and so forth.

### Battery Configured

The solid-state battery is provided in various configurations to suit different applications and device requirements. In some aspects, the battery may be manufactured in a cylindrical form, which can be advantageous for certain types of portable electronics or automotive applications. Alternatively, the solid-state battery may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery. The choice of configuration may depend on factors such as the intended use, space constraints, thermal management requirements, and manufacturing considerations. In some embodiments, hybrid or custom configurations combining elements of different forms may be utilized to meet specific design needs. The versatility in battery form factors can enable the integration of solid-state batteries into a wide range of products, from small wearable devices to large-scale energy storage systems.

### Voltage

The solid-state battery is configured to output a voltage of at or about 1, 2, 3, 4, 5, 6, 10, 12, 20, 24, 30, 40, 48, 50, 60, 70, 80, 90, 96, 100, 200, 300, 400, or 500 V DC. In embodiments, the output voltage of the solid-state battery may be within a range formed by selecting any two numbers listed in the immediately previous sentence, e.g., between about 1 V DC and about 500 V DC.

### Capacity

The solid-state battery is configured to have a specific capacity of at, about, or greater than 100, 110, 120, 130, 140, 150, 160, 170, 180, 190, 200, or 300 mAh/g. In embodiments, the output voltage of the solid-state battery 100 may have a capacity formed by selecting any two numbers listed in the immediately previous sentence, e.g., between about 100 mAh/g and about 300 mAh/g.

### Volume Expansion Calculation

The solid-state battery can include a desirable volume expansion rate. The volume expansion rate may be calculated from an increase amount of thickness after a first cycle of charging and discharging compared to an initial thickness. The volume expansion rate means a ratio of an amount of change in a thickness increased after a first cycle of charging and discharging to an initial thickness of a particular element. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM). Equation 1:

$$Volume expansion rate = [ ( B - A ) / A ] \times 100 C - Rate$$

C-rate as used herein refers to the rate at which the battery is discharged relative to its maximum capacity. For example, a 1 C rate means the discharge current will discharge the entire battery within one hour. That is, for a battery with a capacity of 20 Amp-hrs, a discharge current at a 1 C would be 20 Amps.

Other exemplary ways to measure and calculate the volume expansion rate for a solid-state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### <The Solid Electrolyte-Electrode Assembly>

In some aspects, the electrode is a cathode. The term cathode is used interchangeably with the term positive electrode. Further, the term “SSE-positive electrode integrated film” can be used interchangeably with the term “solid electrolyte-cathode assembly.

In some aspects, a positive electrode current collector is not used. Alternatively, if a positive electrode current collector is used for the electrode, is not particularly restricted, as long as the positive electrode current collector exhibits high conductivity while the positive electrode current collector does not induce any chemical change in a battery to which the positive electrode current collector is applied. For example, the positive electrode current collector may be made of stainless steel, aluminum, nickel, titanium, or plastic carbon. Alternatively, the positive electrode current collector may be made of aluminum or stainless steel, the surface of which is treated with carbon, nickel, titanium, or silver.

The current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The average particle size of the positive electrode active material is usually 0.1 μm to 50 μm, 1 μm to 20 μm, or 0.5 μm to 20 μm, from the viewpoint of improving battery characteristics such as load characteristics and cycle characteristics. The particle size can be adjusted to achieve a ASSB having a large charge/discharge capacity.

A positive electrode active material can include a positive electrode active material suitable for all-solid-state batteries, e.g., transition metal oxides, composite oxides of lithium and transition metals, transition metal sulfides, etc. In some aspects, Fe, Co, Ni, Mn, etc. can be used as the transition metal. Some examples include lithium-containing composite metal oxides such as LiCoO₂, LiNiO₂, LiMnO₂, LiMn₂O₄, LiFePO₄ and LiFeVO₄; transition metal sulfides such as TiS₂, TiS₃ and amorphous MoS₂; transition metal oxides such as Cu₂V₂O₃, or amorphous V₂O—P₂O₅, MoO₃, V₂O₅ and V₆O₁₃. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co_{1-x-y}O₂. In some aspects, the positive electrode material comprises at least one of LiCoO₂, LiMn₂O₄, LiMnO₂, or LiNiO₂. In some aspects, the positive electrode material comprises sulfur.

In addition, an additional material may be used depending on what a lithium secondary battery is used for. For example, a transition-metal-compound-based active material or a sulfide-based active material may be used.

Any suitable solid electrolyte material may be used. In some aspects, a sulfide-containing electrolyte material may be used for the solid electrolyte-electrode assembly. As used here, “sulfide-based electrolyte” refers to an electrolyte that includes inorganic materials containing S which conduct ions (e.g., Li⁺), and which are suitable for electrically insulating the positive and negative electrodes of an electrochemical cell. Exemplary sulfide-containing electrolytes are set forth in Shaojie Chen et al., “Sulfide solid electrolytes for all-solid-state lithium batteries: Structure, conductivity, stability and application,” Energy Storage Materials, Volume 14, Pages 58-74 (September 2018), which is hereby expressly incorporated by reference in its entirety.

For example, many sulfide-containing electrolyte materials are particularly attractive due to their superionic conductivities (as high as ˜10⁻² S cm-1) and deformability. In particular, Li₃P₇S₁₁, Li₁₀GeP₂S₁₂, and Na₃PS₄ and Li₆PS₅Cl have been reported to exhibit high ionic conductivities; some even close to those of liquid electrolytes. According to aspects of the disclosure, the sulfide solid electrolyte materials also provide a low Young's modulus, which is beneficial for producing favorable interface contacts with electrode materials by simple cold pressing at room temperature.

The sulfide-containing solid electrolyte, according to aspects of the disclosure, may contain sulfur (S) and have the ionic conductivity of metal belonging to Group I or II in the periodic table, e.g., Li⁺. Additionally, in an aspect of the present disclosure, the selected solid electrolyte has the ionic conductivity of 1×10⁻⁵ S/cm, or according to some aspects of the disclosure, 1×10⁻³ S/cm or more.

Non-limiting examples of the sulfide-containing solid electrolyte may include Li—P—S-based glass, Li—P—S-based glass ceramic and argyrodite-based sulfide-containing solid electrolyte.

Non-limiting examples of the sulfide-containing solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li₆PS₅X (X=at least one of Cl, Br or I).

In an aspect of the present disclosure, the sulfide-containing solid electrolyte may comprise at least one selected from LPS-based glass or glass ceramic such as xLi₂S-yP₂S₅, or an argyrodite-based sulfide-containing solid electrolyte (Li₆PS₅X; X=Cl, Br, I).

In another aspect, the solid electrolyte may include a solid electrolyte commonly used in the all-solid-state battery, such as an inorganic solid electrolyte or an organic solid electrolyte may be used.

In tie case of the inorganic solid electrolyte, a ceramic material, a crystalline material or an amorphous material may be used. For instance, inorganic solid electrolytes such as thio-LISICON (Li_{3.25}Ge_{0.25}P_{0.75}S₄), Li₂S—SiS₂, LiI—Li₂S SiS₂, Li— Li₂S—P₂S₅, LiI—Li₂S P₂O₅, LiI—Li₃PO₄—P₂S₅, Li₂S—P₂S₅, Li₃PS₂, Li₃P₂S₁₁, Li₂O—B₂O₃, Li₂O—B₂O₃—P₂O₅, Li₂O—V₂O₅ SiO₂, Li₂O—B₂O₃, Li—PO₄, Li₂WO₄—B₂O₃, LiPON, LiBON, Li₂O—SiO₂, LiI, Li₃N Li₅La₃Ta₂O₁₂, Li₇La₃Zr₂O₁₂, Li₆BaLa₂TaO₁₂, Li₃PO_{(4-3/2w)}Nw (wherein w is w<), and Li_{3.6}Si_{0.6}P_{0.4}O₄ can be used.

The average size of sulfide-based particles is, for example, 0.1 μm to 50 μm, or 0.5 μm to 20 μm, which is within the size range of sulfide-based particles used in well-known all-solid-state batteries. In the case in which the average size of the sulfide-based particles is less than the above range, the sulfide-based particles may form lumps. In the case in which the average size of the sulfide-based particles is greater than the above range, on the other hand, the porosity of the manufactured solid electrolyte is high, whereby the characteristics of the battery may be deteriorated. For example, the capacity of the battery may be reduced.

In some aspects, the sulfide-based particle has an ion conductivity of 1×10⁻⁴ S/cm or more. In other aspects, the sulfide-based particle has an ion conductivity of 1×10⁻³ S/cm or more.

In addition to the above-mentioned sulfide-based solid electrolytes, other well-known solid electrolytes may also be used. For example, an inorganic solid electrolyte, such as Li₂O B₂O₃, Li₂O—B₂O₃—P₂O₅, Li₂O-V₂O₅ SiO₂, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}Nw (w<1), or Li_{3.6}S_{10.6}P_{0.44}, may be used.

In addition, examples of the organic solid electrolyte include organic solid electrolytes prepared by nixing lithium salt to polymeric materials such as polyethylene derivatives, polyethylene oxide derivatives, polypropylene oxide derivatives, phosphate ester polymers, agitation lysine, polyester sulfide, polyvinyl alcohol, and polyvinylidene fluoride. In this case, these may be used alone or in combination of at least one.

The above-described coated sulfide-containing electrolyte material can be used for a solid electrolyte for an all-solid-state battery. The all-solid-state battery contains a positive electrode, a negative electrode, with the solid electrolyte interposed therebetween.

Meanwhile, the positive electrode and the negative electrode for the all-solid-state battery according to aspects of the present disclosure are not particularly limited and any suitable one known in the art can be used.

The all-solid-state battery proposed according to aspects of the present disclosure defines the constitution of the solid electrolyte as described above, and the other elements constituting the battery, that is, the positive electrode and the negative electrode, are not particularly limited in the present disclosure and follow the description below.

In an aspect, the negative electrode for the all-solid-state battery is a lithium metal alone, or negative electrode active material can be laminated on the negative electrode current Collector.

### <Manufacturing>

In certain aspects, the all-solid-state battery is manufactured through a dry process, in which electrode powder (e.g., plurality of cathode particles), a solid electrolyte powder (e.g., wherein the solid electrolyte is provided in the form of particles or powders having an average particle size less than 5 m), and a binder are provided, and the solid electrolyte-cathode assembly is formed by a co-rolling process. In aspects, the solid electrolyte particles may optionally be ball-milled to reduce the particle size, which expands the contact area between cathode materials and the solid electrolyte, resulting in higher Li transport characteristics. According to some aspects of the invention, the dry-process is a sustainable and promising fabrication method for all solid-state batteries by eliminating solvents. According to some aspects, a thin and robust solid-state electrolyte-cathode assembly can be prepared by a dry-process approach that enhances mechanical stability of SSE layers from film fabrication to cell operation.

The co-rolling process can be carried out using a rotating tray method, a rotating cylindrical method, or a rotating cone method. The co-rolling process may be a continuous roll-to-roll process.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

In some aspects, the cathode particles have an average particle size of 0.1 μm to 20 μm; 0.1 μm to 10 μm; 1 μm to 5 μm; or 1 μm to less than 5 μm. For example, the cathode particles can be in the sub-micron to micron range.

In some aspects, the SSE particles have an average particle size of 0.1 μm to 20 μm; 0.1 μm to 10 μm; 1 μm to 5 μm; or 1 μm to less than 5 μm. For example, the SSE particles can be in the sub-micron to micron range.

In some aspects, in the solid electrolyte-cathode assembly, a weight ratio of the cathode particles to the solid electrolyte is from 1:1 to 1:5. In some aspects, a weight ratio of the cathode particles to the solid electrolyte is about 1:2.

In some aspects, the amount of binder is less than about 5% wt., less than about 2% wt., less than about 1% wt., or less than about 0.5% wt. The selection of binder is not limited. For instance, polytetrafluoroethylene (PTFE) binder has a drawback due to its poor electrochemical reduction stability; however, other binders may have inferior physical properties requiring higher amounts of binder. In some aspects, the selection of binder should take into account the ability to minimize the amount of binder in the SSE layer fabrication, while minimizing the risk of mechanical failure.

In some aspects, the dry-process approach enhances mechanical stability of SSE layers from film fabrication to cell operation. By co-rolling thick SSE and positive electrode feeds, a uniform, thin SSE layer and a high loading positive electrode layer with high active material ratio are simultaneously achieved.

In some aspects, after the co-rolling process, the SSE layer will a thickness of greater than or equal to 500 μm, a thickness of greater than or equal to 250 μm, a thickness of greater than or equal to 200 μm, a thickness of greater than or equal to 100 μm or a thickness of greater than or equal to 50 μm. In some aspects, the SSE layer has a thickness less than 500 μm, less than 400 μm, less than 300 μm, less than 250 μm, less than 200 μm, or less than 150 μm, less than 100 μm, less than 90 μm, less than 80 μm, less than 70 μm, less than 60 μm, or less than 50 μm, less than 40 μm, less than 30 μm or less than 20 μm.

In some aspects, after the co-rolling process, the cathode layer has a thickness of greater than or equal to 25 μm, a thickness of greater than or equal to 15 μm, a thickness of greater than or equal to 10 μm, a thickness of greater than or equal to 7 μm or a thickness of greater than or equal to 5 μm. In some aspects, the cathode layer has a thickness less than 100 μm, less than 90 μm, less than 80 μm, less than 70 μm, less than 60 μm, or less than 50 μm.

Some aspects relate to where the ratio of a thickness for the cathode layer to a thickness of the solid electrolyte layer (in the solid-state electrolyte-cathode assembly) is about 20:1, about 18:1, about 15:1, about 14:1, about 12:1, about 11:1, about 10:1, about 5:1, about 4:1, about 2:1, about 1:1, about 1:5, about 1:4, from about 1:1 to 1:3, from about 1:1 to 1:2, or about 1:1. The ratio of a thickness for the cathode layer to a thickness of the solid electrolyte layer may be controlled to improve the layer uniformity and/or surface quality of the resulting solid electrolyte-cathode assembly.

In some aspects, the solid-state electrolyte-cathode assembly has a high active material ratio of greater than about 90%, greater than about 85%, greater than about 80%, greater than about 75%, greater than about 70%, greater than about 65%, greater than about 60%, greater than about 55%, greater than about 50%, or greater than about 45%.

In some aspects, the solid-state electrolyte-cathode assembly has a high loading positive electrode layer, e.g., greater than about 10 mAh cm⁻², greater than about 7 mAh cm⁻², greater than about 5mAh cm⁻², greater than about 4 mAh cm⁻², or greater than about 3mAh cm².

This SSE-positive electrode integrated film exhibits enhanced physical properties and cyclability (>80% retention after 500 cycles) at low stack pressure (2 MPa) compared to the freestanding counterparts, attributed to reinforced and intimate SSE-positive electrode interface constructed during co-rolling process.

### EXAMPLES

The following examples are not intended to be limiting. The above disclosure provides many different aspects for implementing the features of the disclosure, and the following examples describe certain aspects. It will be appreciated that other modifications and methods known to one of ordinary skill in the art can also be applied to the following experimental procedures, without departing from the scope of the disclosure.

### Experimental Examples

A co-rolled film according to disclosed aspects was prepared as follows. For a cathode layer, polycrystalline LiNi_{0.5}Co_{0.1}Mn_{0.1}O₂(PC-NCM, NCM811, LG Chem) or single crystalline LiNi_{0.82}Co_{0.11}Mn_{0.07}O₂(SC-NCM, NCM82, MSE Supplies), Li₆PS₅Cl (LPSCl, Mitsui), and vapor-grown carbon fiber (VGCF, Sigma-Aldrich) (80:17:3 by weight) were mixed in a mortar and pestle for 30 min. The powder mixture and polytetrafluoroethylene (PTFE, Chemours) (100:0.5 by weight) were transferred into a 20 mL vial and vortex mixed at 3000 rpm for 3 min. The mixture was shear mixed in a mortar and pestle until dough was formed. The dough was roll-pressed using roll-press machine (TMAXCN) at 120° C. with a fixed roller gap of 2 mm by folding and rotating, which was repeated 30 times to fibrillate PTFE binder. For an SSE layer, LPSCl (NEI Corporation) was ball-milled at 400 rpm for 2 h using planetary ball miller (TMAXCN) in a zirconia jar with zirconia balls sealed in an argon-filled atmosphere to reduce particle size. Ball-milling was conducted twice to homogenize particle size. With ball-milled LPSCl and PTFE (100:0.1 by weight), the SSE layer was obtained using the same procedure as the cathode layer.

For the co-rolled film, cathode and SSE, feed layers were controlled to a weight ratio of approximately 3:5:1. The initial thickness of SSE feed layer was fixed to 600 μm. After cutting feed layers into a 2.54 cm×2.54 cm (1 in×1 in) dimension using a cutter, the feed layers were stacked and roll-pressed with a desired reduction temperature (120° C. or 30° C.) and reduction thickness (20 μm or 100 μm) until desired cathode loading was achieved. The cathode loading of co-rolled film was calculated and controlled based on the weight ratio of SSE feed to cathode feed.

In the experiments below, Examples according to disclosed aspects were formed as described above.

### Experiment 1

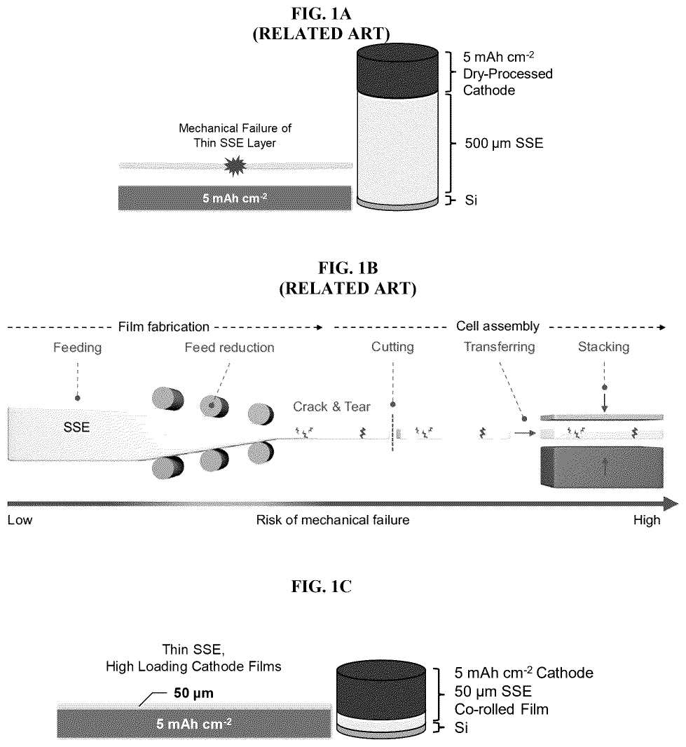

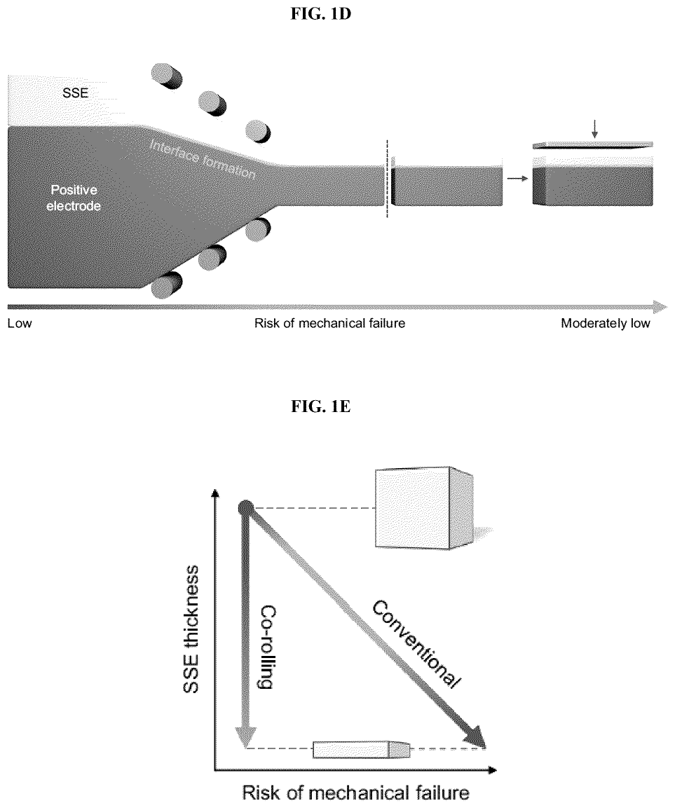

FIG. 1A and FIG. 1B shows Comparative Example 1 formed conventionally and FIG. 1C and FIG. 1D shows Example 1 formed according to disclosed aspects where the SSE assembly is formed by co-rolling a plurality of cathode particles and a plurality of solid electrolyte particles, as discussed above. As seen in FIG. 1A, in Comparative Example 1, there is a problem of mechanical failure when using a thin SSE to form an assembly, which is due to poor mechanical property of the film. As seen in FIG. 1C, in Example 1, there is simultaneous production of the assembly, which mitigates mechanical failure of the thin SSE layer.

In particular, FIG. 1B and FIG. 1D illustrates a comparison of conventional dry-process and co-rolling dry process. In conventional dry-process, a thick SSE feed is progressively thinned through a series of roll-pressing (FIG. 1B). Assuming a linear relationship between the thickness and mechanical property of the film, the risk of mechanical failure increases as the thickness of the film decreases, which makes fabricating a thin but robust SSE film difficult (FIG. 1E). This low processability results in a freestanding SSE film that is prone to crack and tear (FIGS. 1A and 1B), which makes it less scalable and renders the cell assembly process including cutting, transferring, and stacking challenging.

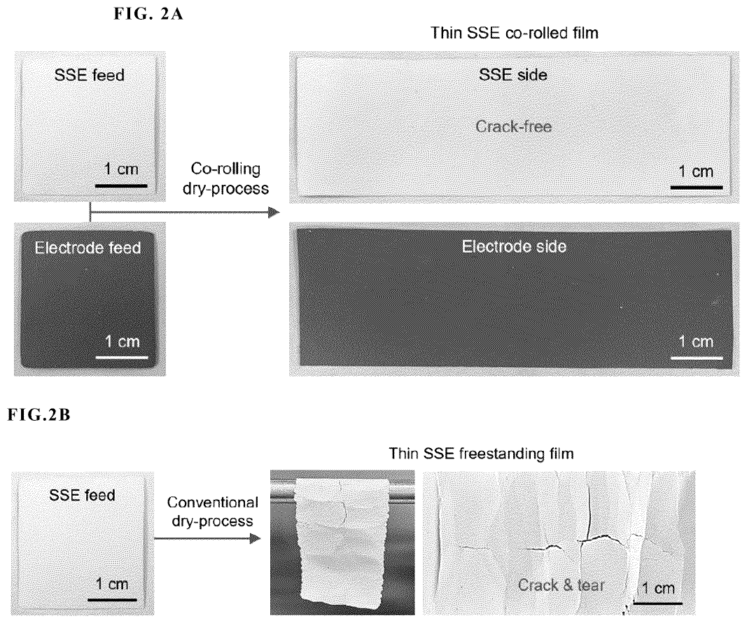

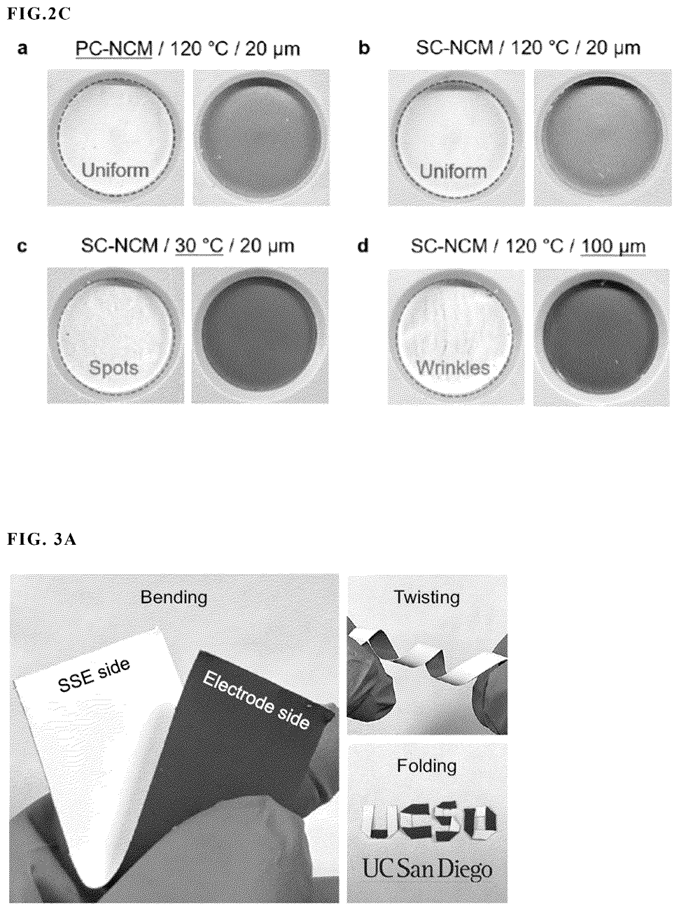

Although the binder content can be increased to enhance the mechanical strength, this typically compromises ionic conductivity and electrochemical stability. Thus, creating a thin but robust SSE layer is a bottleneck in terms of mechanical properties and processability for dry-processing ASSBs. In contrast, the co-rolling dry process roll-presses thick SSE and positive electrode feed layers together, thus reducing the total thickness without requiring a thin SSE layer in a freestanding form (FIG. 1D). This approach significantly reduces the risk of mechanical failures compared to the conventional approach (FIG. 1E). Accordingly, an as-fabricated thin SSE co-rolled film displayed a uniform and crack-free surface of both SSE and positive electrode sides (FIG. 2A). During the co-rolling process, a robust SSE-positive electrode interface is formed which facilitates the cell assembly process with mitigated risk of mechanical failure. Consequently, a practical ASSB can be realized with a thin SSE, high loading and active material ratio positive electrode, and high-capacity negative electrode, as well as a robust SSE-positive electrode interface for enhanced low stack pressure operation.

### Experiment 2

FIG. 2A shows Example 2 formed according to disclosed aspects where the solid electrolyte-electrode assembly is formed by co-rolling a plurality of cathode particles and a plurality of solid electrolyte particles, as discussed above, and Comparative Example 2 (freestanding) formed without co-rolling. As seen in FIG. 2B, in Comparative Example 2, there is a problem of cracking when using a freestanding SSE film to form an assembly, which is due to poor mechanical property of the film. As seen in FIG. 2A, in Example 2, there is no cracking of the thin SSE layer.

### Experiment 3

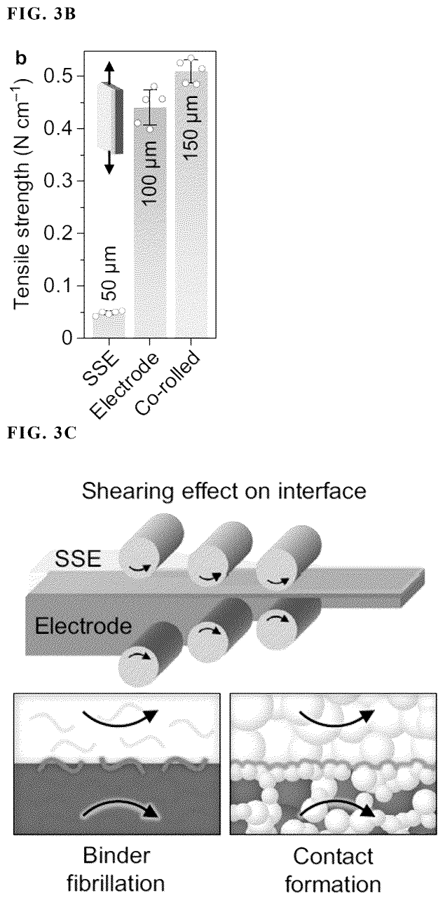

FIG. 3B shows Example 3 (co-roll) formed according to disclosed aspects where the solid electrolyte-electrode assembly is formed by co-rolling a plurality of cathode particles and a plurality of solid electrolyte particles, as discussed above, and Comparative Example 3B (SSE) and Comparative Example 4 (cathode) formed without co-rolling. As seen in FIG. 3B, Example 3 exhibited higher tensile strength than either Comparative Example 3 (SSE) or Comparative Example 4 (cathode).

### Experiment 4

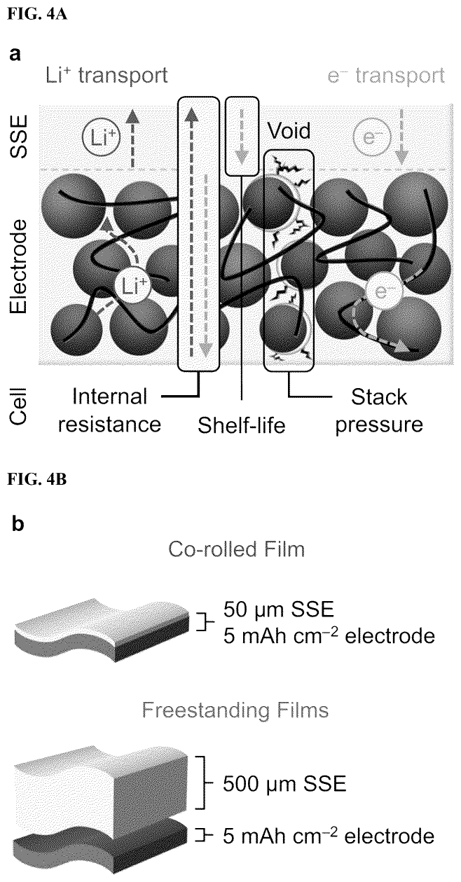

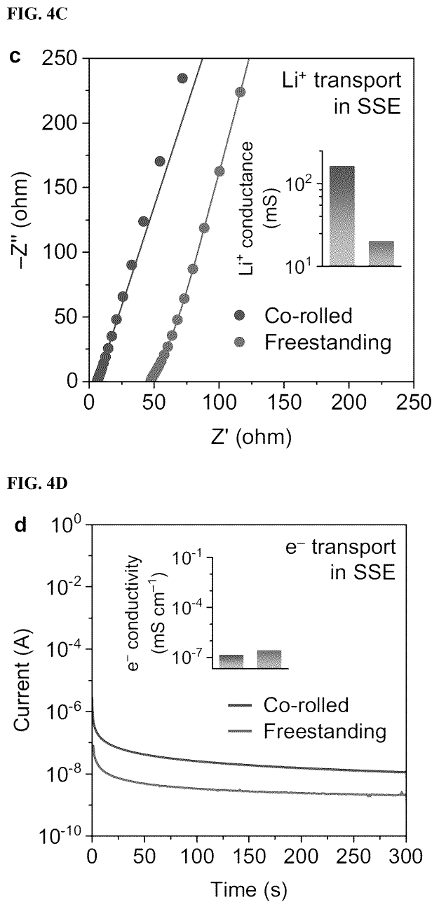

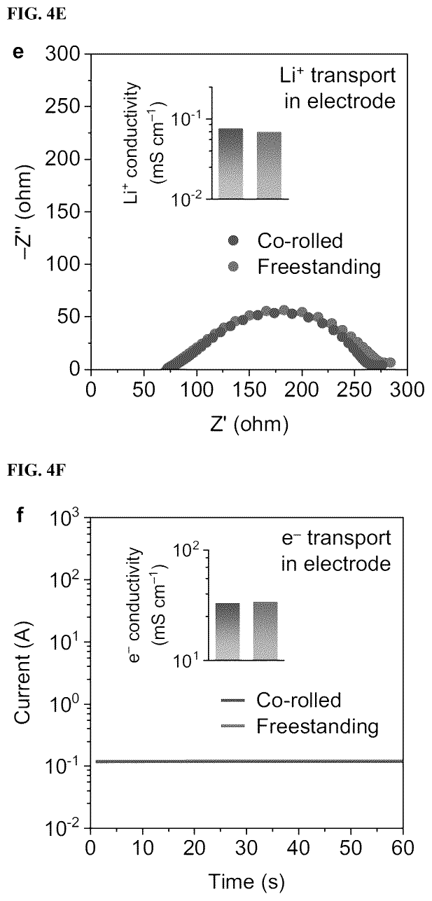

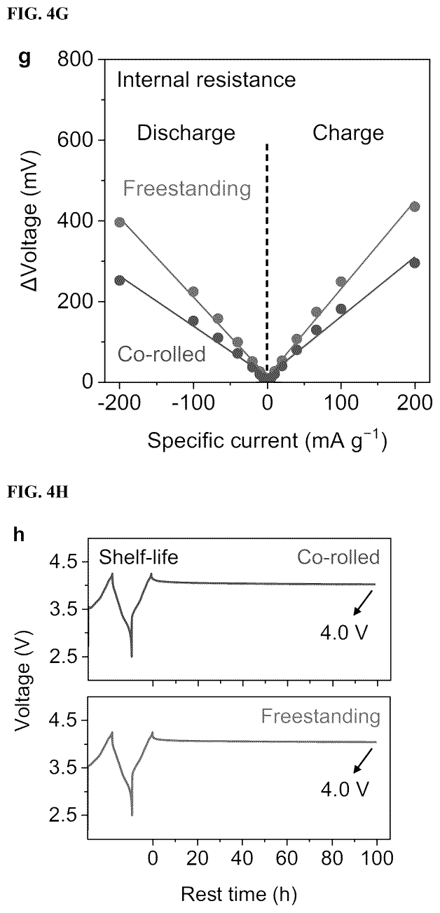

FIGS. 4A and 4B show Example 4 formed according to disclosed aspects where the solid electrolyte-electrode assembly is formed by co-rolling a plurality of cathode particles and a plurality of solid electrolyte particles, as discussed above, and Comparative Example 5 (freestanding) formed without co-rolling. FIGS. 4C and 4D illustrate the electrochemical characterizations of Example 4 and Comparative Example 5. As seen in FIG. 4C, Example 4 exhibited a superior lithium ion transport profile in the solid electrolyte compared to Comparative Example 5. As seen in FIG. 4D, Example 4 exhibited a superior lithium ion transport profile in the cathode compared to Comparative Example 5.

### Experiment 5

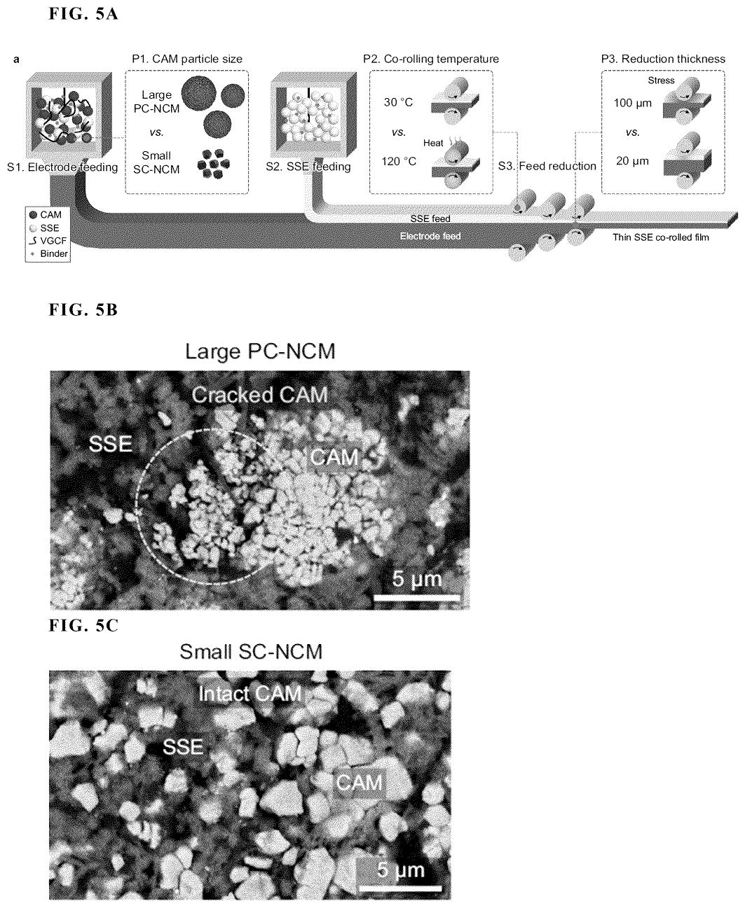

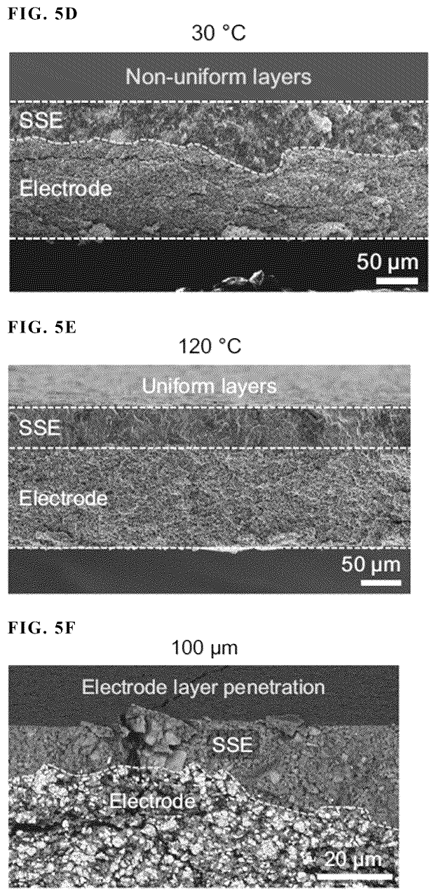

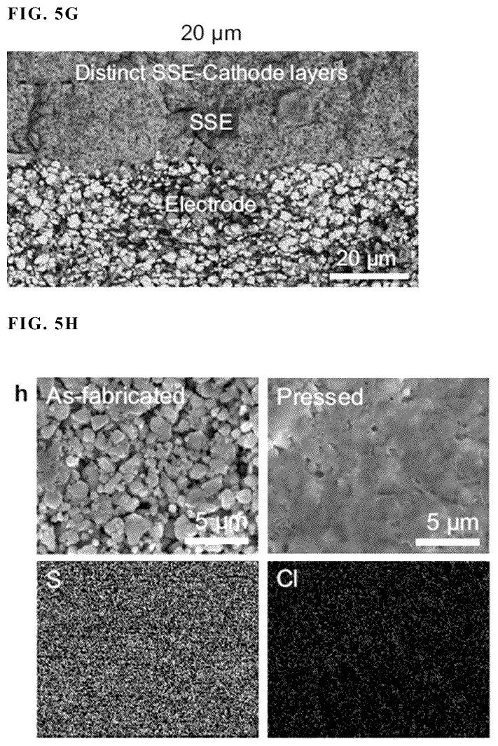

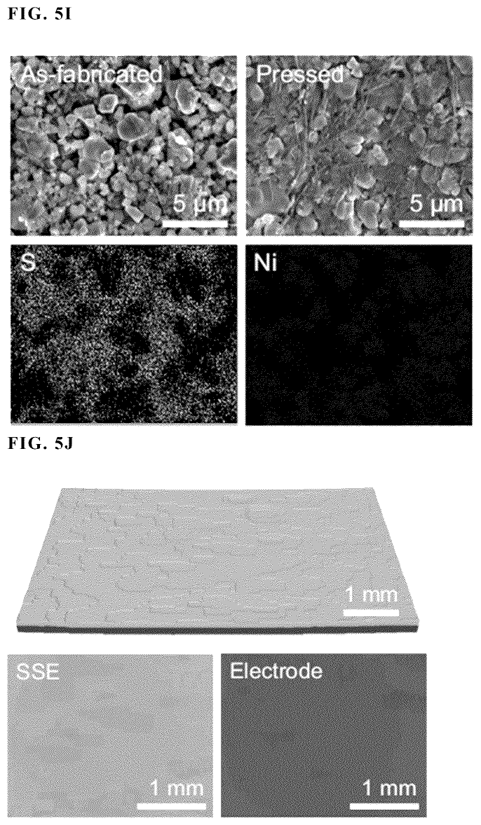

A co-rolling dry-process was designed based on continuous roll-to-roll manufacturing, which is essential for scalable fabrication of battery components (FIG. 5A). This process involves three fabrication steps (S1-3). First, cathode active material (CAM), SSE, vapor-grown carbon fiber (VGCF), and binder are mixed to form the positive electrode feed layer. Second, SSE and binder are mixed to form the SSE feed layer which is placed on the positive electrode feed layer. Third, SSE-positive electrode feed layers are reduced until they reach the desired thickness.

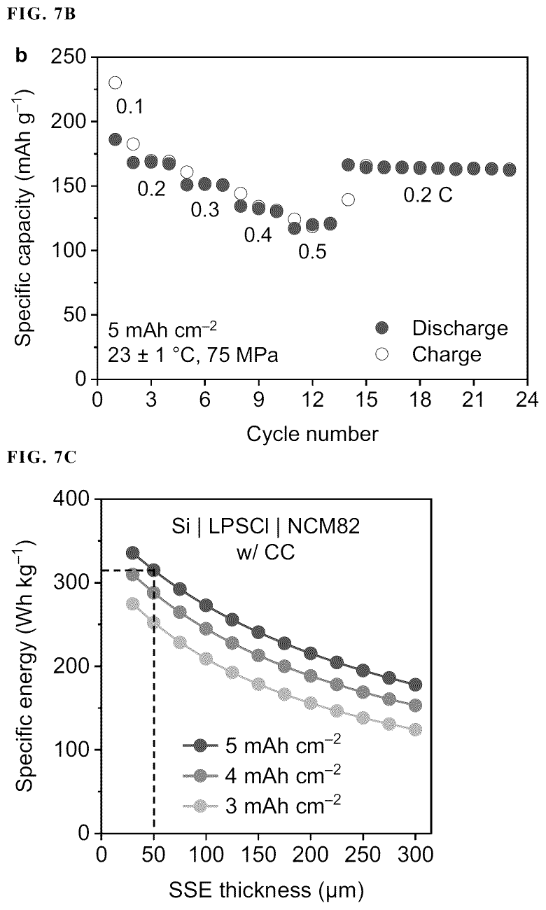

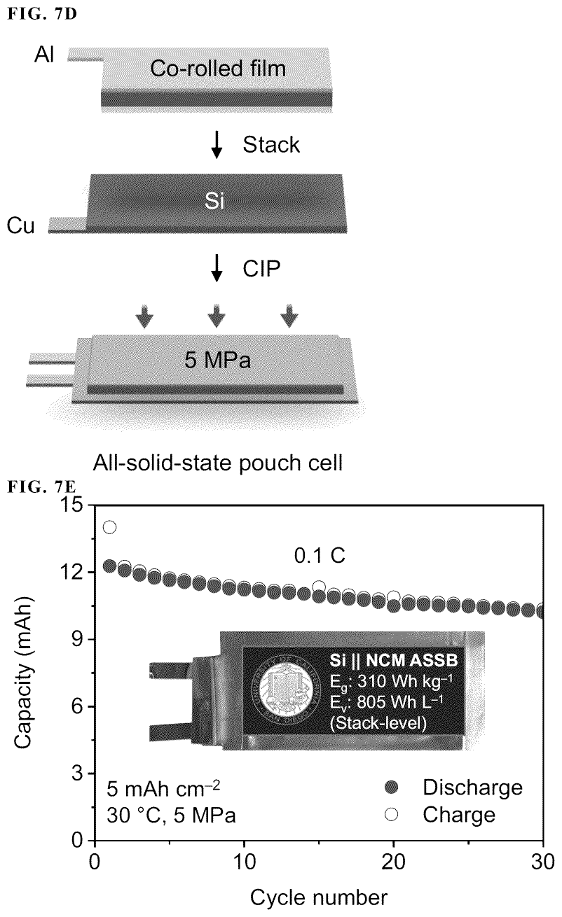

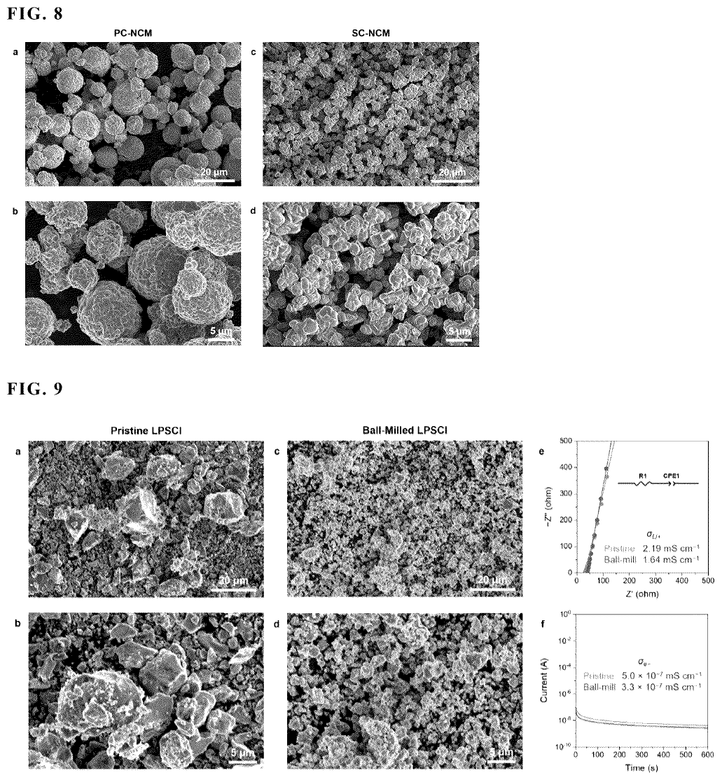

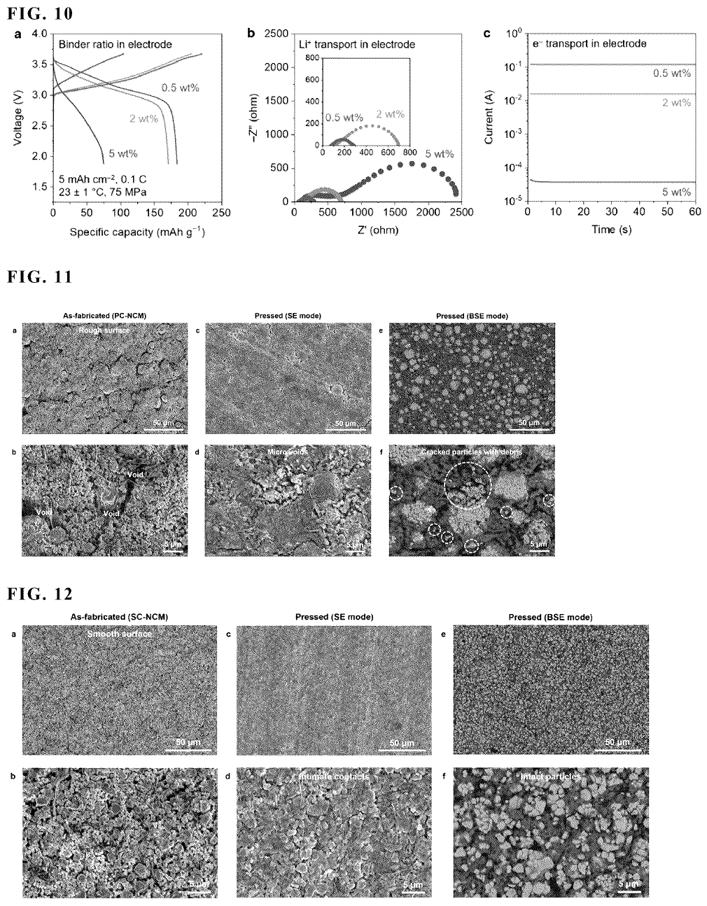

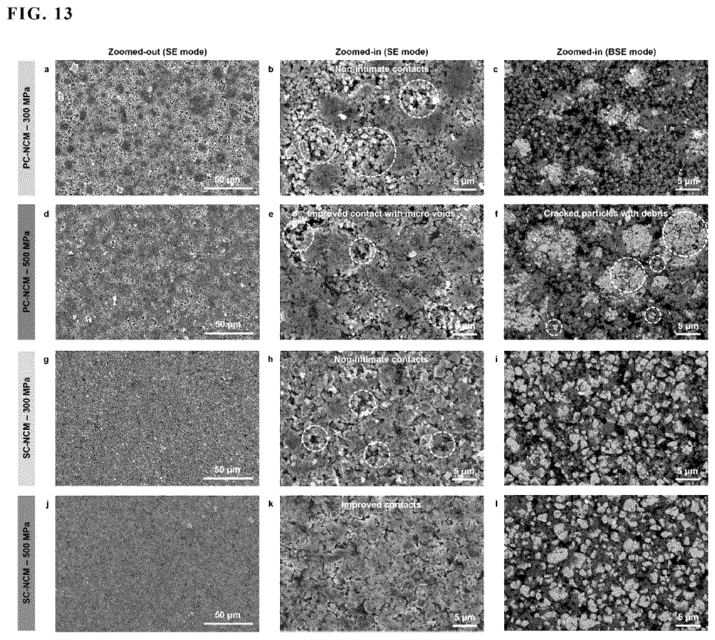

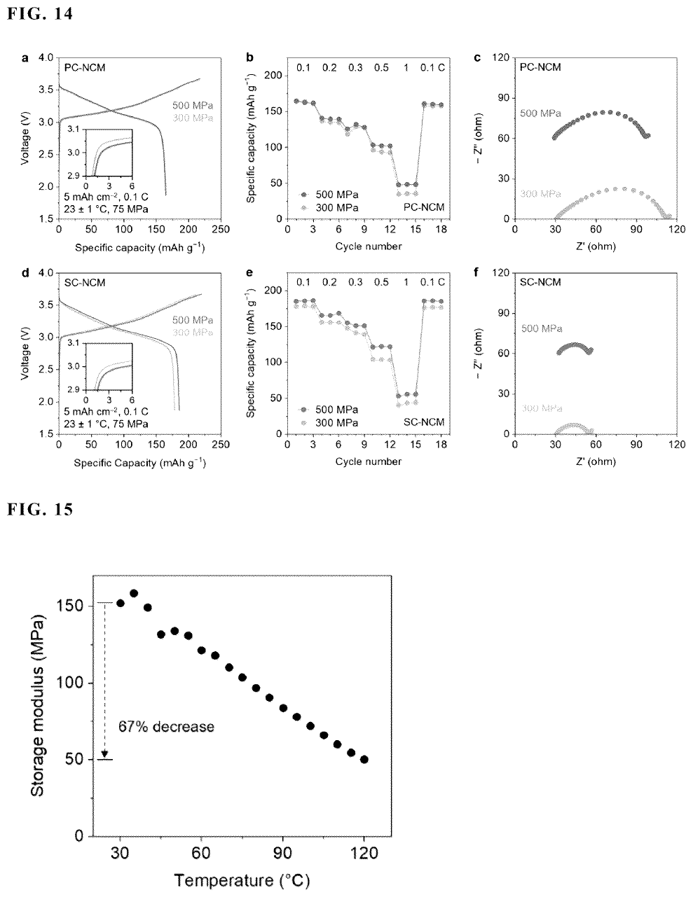

Three fabrication parameters (P1-3), CAM particle size, co-rolling temperature, and reduction thickness, were studied based on the designed fabrication process to achieve optimal structure and uniformity of positive electrode and SSE layers. The co-rolled films were fabricated with different parameters and analyzed after pressing (FIG. 2C). First, two different types of CAM (large poly-crystalline LiNi_{0.5}Co_{0.1}Mn_{0.1}O₂, NCM811, PC-NCM of 5-15 μm and small single crystalline LiNi_{0.82}Co_{0.M}Mn_{0.07}O₂, NCM82, SC-NCM of 3-5 μm) were compared (FIG. 8). For SSE, Li₆PS₅Cl (LPSCl) with small particle size (<1 μm) was used for positive electrode layer to minimize tortuosity, and relatively small particle size (2-5 μm) was used for SSE layer which was prepared by ball-milling (FIG. 9). The active material ratio in positive electrode was fixed to 80 wt % for high energy density, and the binder ratio of 0.5 wt % was used to minimize the hinderance of Li⁺ and e⁻ transports in the positive electrode layer (FIG. 10). After fabricating co-rolled films and pressing with fabrication pressure of 500 MPa, photos displayed a uniform surface on SSE and positive electrode sides for both large PC-NCM and small SC-NCM (FIGS. 2C, (a) and (b)) but scanning electron microscopy (SEM) images of positive electrode side showed cracked PC-NCM particles (FIG. 5B) and intact SC-NCM particles (FIG. 5C). As-fabricated films before press were compared to under-stand this difference. The film with PC-NCM showed a rough surface with obvious voids between large CAM and small SSE particles before press, which led to severe particle cracking after press (FIG. 11). Meanwhile, the film with SC-NCM showed a smooth surface with dense particle packing before press, which formed intimate contacts without obvious cracking after press (FIG. 12). The cracking of large PC-NCM was also confirmed in powder positive electrode composite at different fabrication pressures of 300 and 500 MPa (FIG. 13). Since small SC-NCM also showed higher discharge capacities, better rate capability, and lower SSE-positive electrode resistance compared to large PC-NCM (FIG. 14), small SC-NCM was used for further discussion.

Second, the co-rolling temperature determines the elongation of feeds. The co-rolling temperatures of 30 and 120° C. were studied by controlling the temperature of the rollers. A photo of SSE side of the film with 30° C. co-rolling displayed irregular spots (FIG. 2C, (c)). From cross-sectional SEM images, the film with 30° C. co-rolling showed non-uniform layers of SSE and positive electrode, whereas that with 120° C. reduction showed uniform layers (FIG. 5D and FIG. 5E). This is due to thermo-mechanical properties of the binder, in which the modulus decreases by 67% from 30 to 120° C. (FIG. 15). As a result, the feed layers can be more easily deformed at elevated temperatures than at lower temperatures, leading to more uniform elongation of SSE and positive electrode layers during co-rolling. Third, the degree of reduction affects stress applied on feeds. The reduction thickness of 20 and 100 μm were compared by decreasing the roller gap distance by the corresponding reduction thickness every step. A photo of SSE side of the film displayed severe wrinkles for 100 μm reduction (FIG. 2C, (d)), which was due to the penetration of positive electrode layer through SSE layer (FIG. 5F). Contrarily, the film with 20 μm reduction showed distinct layers of SSE and positive electrode without penetration (FIG. 5G), which was due to the less stress applied onto the feed layers during reduction step. Thus, co-rolling temperature and reduction thickness of 120° C. and 20 μm were used for optimal uniformity of the co-rolled film.

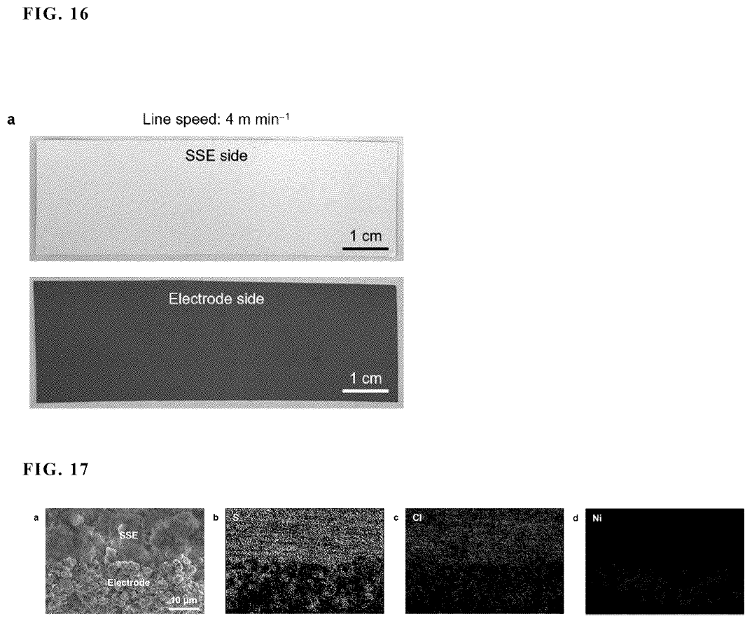

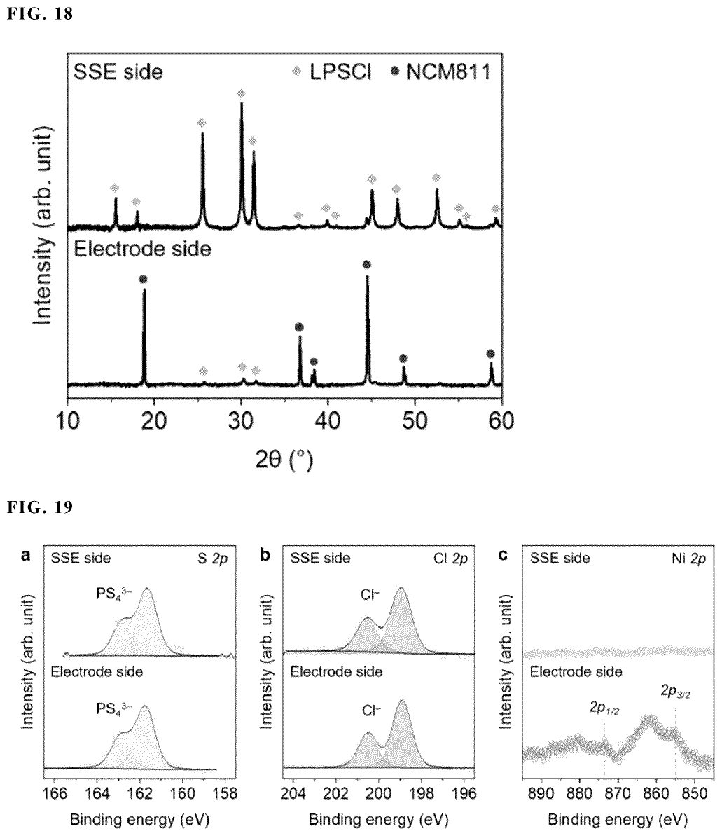

With these optimized fabrication parameters, a fast line speed (4 μm min⁻¹) could be realized in our laboratory roller machine to fabricate a thin SSE layer (FIG. 16A), demonstrating its potential capability of high-throughput fabrication. Moreover, SEM images and energy dispersive X-ray spectroscopy (EDS) mapping of a co-rolled film showed a dense surface of LPSCl on SSE side (FIG. 2H), intimate coverage of SC-NCM with LPSCl on positive electrode side (FIG. 2I), and desired SSE-positive electrode interphase from a cross-section (FIG. 17). Micro-computed tomography (CT) reconstruction of co-rolled film further confirmed the structure of SSE and positive electrode on a larger scale (FIG. 2J). The bulk and surface properties of SSE and positive electrode sides were also confirmed with X-ray diffraction (XRD) (FIG. 18) and X-ray photoelectron spectroscopy (XPS) (FIG. 19).

### Physical, Mechanical, and Electrochemical Properties of Co-Rolled Film

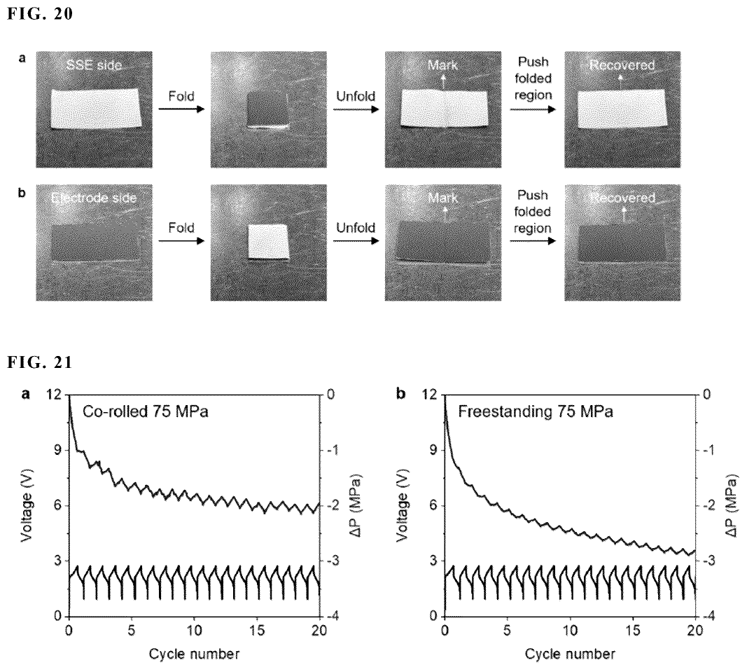

The co-rolled film exhibited improved physical properties despite a thin SSE layer (50 μm). The film showed good flexibility (FIG. 3A), recoverability (FIG. 20) and integrity that are difficult to achieve with a thin SSE freestanding film. The tensile strength value of co-rolled film (0.510 N cm⁻¹) was approximately a sum of freestanding SSE and positive electrode films (0.049 and 0.441 N cm⁻¹)(FIG. 3B). This indicates that the mechanical property of co-rolled film is determined by both SSE and positive electrode layers instead of only SSE layer, which greatly benefits the mechanically fragile SSE layer. Compared to other published works, this co-rolling dry-process utilized the lowest binder content (<0.1 wt %) and still enabled a thin SSE layer (50 μm), demonstrating the effectiveness of this co-rolling dry-process for fabricating thin and robust SSE layer with minimal binder reliance (FIG. 3C).

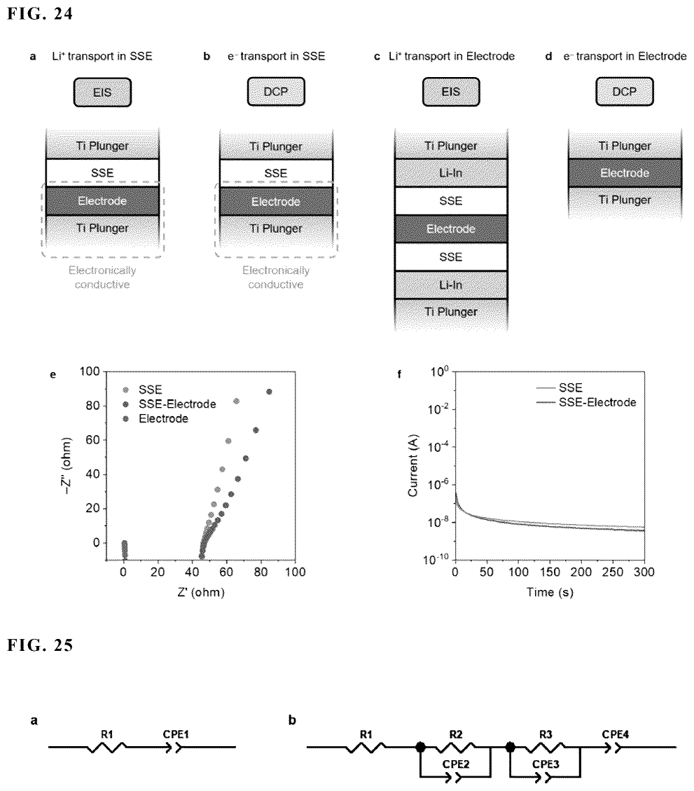

To implement this co-rolled film into a practical battery device, ensuring the desired electrochemical property of both SSE and positive electrode layers is crucial. Pathways of Li+ and e− transportation in SSE and positive electrode layers as well as their effects on a cell property are illustrated (FIG. 4A). Since their transport properties are affected by not only the composition but also structure after fabrication, co-rolled and freestanding films of the same compositions are fabricated and characterized with appropriate cell configurations (FIG. 4B and FIG. 24). Note that a much thicker SSE layer of 500 μm was used for freestanding SSE film due to its limited processability, but to ensure a comparable film quality. First, Li+ transport in the SSE layer was characterized by electrochemical impedance spectroscopy (EIS). A much higher ionic conductance of co-rolled film than that of freestanding films (164 vs. 20 mS, corresponding to ionic conductivity of 1.04 vs. 1.29 mS cm⁻, respectively) was observed, which was attributed to a much thinner SSE layer (FIG. 4C, FIG. 25A). Table 1 below shows EIS equivalent circuit fitting values of Li⁺ transport in SSE layer of co-rolled film and freestanding films in FIG. 9C.

TABLE 1

| Co-rolled film | | | | Freestanding films | | | |
|---|---|---|---|---|---|---|---|
| Element | Value | Error | Unit | Element | Value | Error | Unit |
| R1 | 6.098 | 0.2056 | Ω | R1 | 49.48 | 0.5371 | Ω |
| CPE1-T | 3.69E−06 | 8.01E−08 | F s^{P-1} | CPE1-T | 6.51E−06 | 7.11E−08 | F s^{P-1} |
| CPE1-P | 0.80011 | 0.002965 | — | CPE1-P | 0.80558 | 0.001974 | — |

| | |
|---|---|
| χ² = 0.01502 | χ² = 0.004286 |

Second, e− transport in SSE layer was characterized by direct current polarization (DCP). It showed comparable electronic conductivities (1.4×10⁻⁷ and 2.6×10⁻⁷ mS cm⁻¹), suggesting electron insulation (FIG. 4d). Next, Li⁺ transport in positive electrode layer presented comparable effective ionic conductivities (0.076 and 0.069 mS cm⁻¹), which implied good distribution of SSEs forming ion pathways in positive electrode layer (FIG. 4E, FIG. 25B). Table 2 below shows EIS equivalent circuit fitting values of Li+ transport in positive electrode layer of co-rolled film and freestanding films in FIG. 9E.

TABLE 2

| Co-rolled film | | | | Freestanding films | | | |
|---|---|---|---|---|---|---|---|
| Element | Value | Error | Unit | Element | Value | Error | Unit |
| R1 | 68.26 | 2.7599 | Ω | R1 | 70.9 | 0.74489 | Ω |
| R2 | 112.4 | 10.077 | Ω | R2 | 111.7 | 6.6145 | Ω |
| CPE2-T | 0.00047836 | 1.2205E−05 | F s^{P-1} | CPE2-T | 0.00058069 | 1.1092E−05 | F s^{P-1} |
| CPE2-P | 0.80737 | 0.021546 | — | CPE2-P | 0.80899 | 0.014236 | — |
| R3 | 72.84 | 14.889 | Ω | R3 | 92.45 | 8.3963 | Ω |
| CPE3-T | 0.0021416 | 0.00022355 | F s^{P-1} | CPE3-T | 0.0021085 | 0.00013923 | F s^{P-1} |
| CPE3-P | 0.40015 | 0.022624 | — | CPE3-P | 0.39997 | 0.018399 | — |
| CPE4-T | 0.064197 | 0.021041 | F s^{P-1} | CPE4-T | 0.17251 | 0.1447 | F s^{P-1} |
| CPE4-P | 0.077914 | 0.031419 | — | CPE4-P | 0.17043 | 0.083097 | — |

| | |
|---|---|
| χ² = 0.00032217 | χ² = 0.00011788 |

Last, e transport in the positive electrode layer showed similar electronic conductivities (33 and 34 mS cm⁻¹), suggesting well-constructed electron pathways by VGCF in the positive electrode layer (FIG. 4F). In summary, these results confirm the desired electrochemical properties in both SSE and positive electrode layers of co-rolled film.

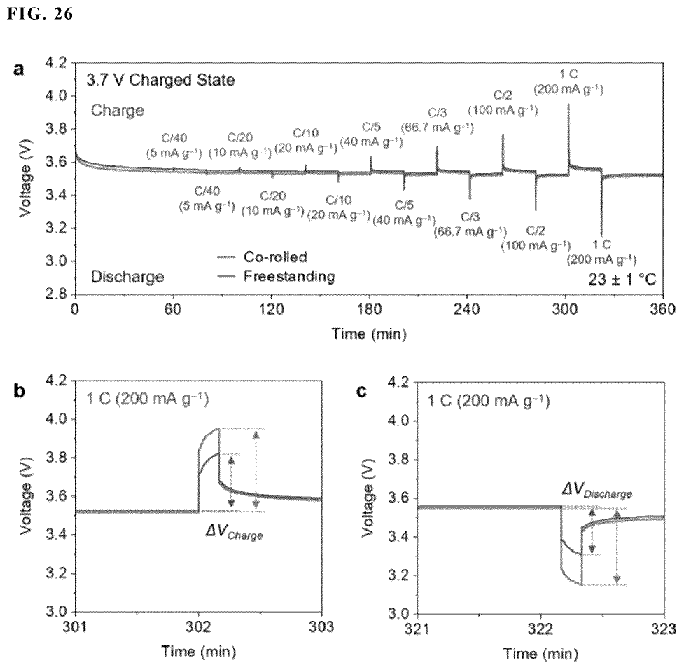

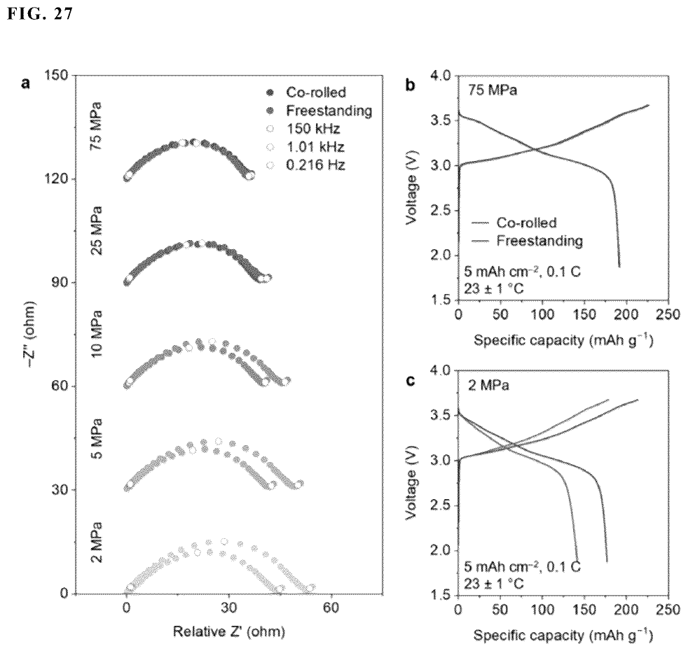

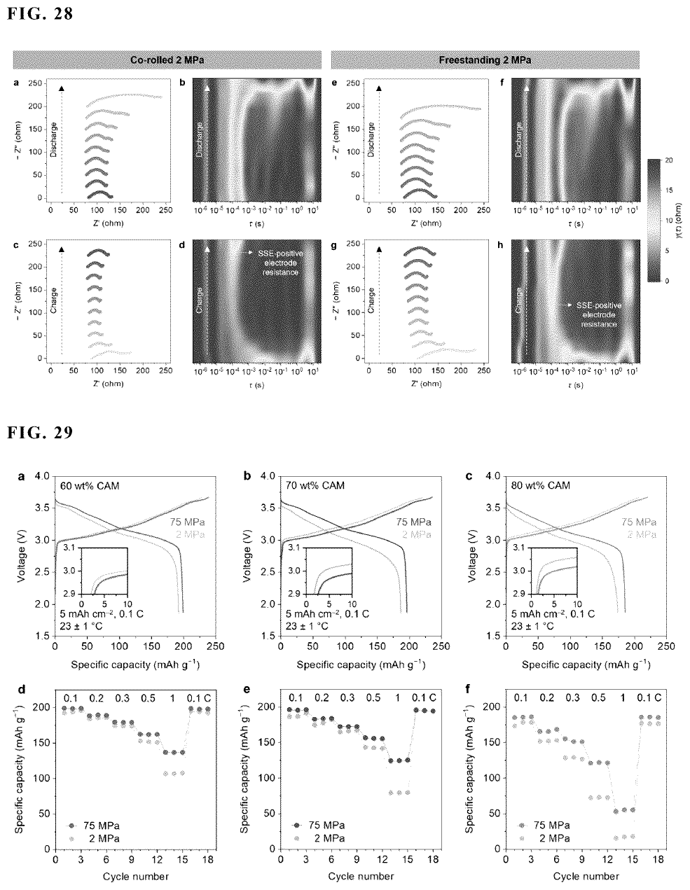

The electrochemical properties were further analyzed in a working cell configuration. First, the internal resistance of a cell was mainly affected by Li⁺ transport in SSE and positive electrode layers and e⁻ transport in positive electrode layer. It was characterized by applying a pulse of different currents and measuring a change in the voltage response (FIG. 4G and FIG. 26). The fitted slopes of polarizations for co-rolled film are much lower than those of free− standing films (−1.24 vs. −1.97 for discharge and 1.48 vs. 2.18 for charge) due to the shorter ion pathway of a thinner SSE layer in co-rolled film. Second, the shelf-life of a cell is greatly affected by e transport in the SSE layer (i.e., electron leakage) in a charged state. The shelf-life property was evaluated by charging the cell to 4.25 V after an activation cycle and measuring cell voltage (FIG. 4H). The cell voltage for both co-rolled and freestanding films remained similar after resting for 100 h (˜4.0 V), indicating a similar electron leakage through the SSE layer despite a much thinner SSE layer of co-rolled film. Last, stack pressure secures Li⁺ and e⁻ transport pathways against void formation during cycling. These effects were investigated with EIS and distribution of relaxation times (DRT) analysis by varying stack pressures after cycle (FIG. 27A). Interestingly, co-rolled films showed less increase in SSE-positive electrode resistance than free-standing films with lowering stack pressure from 75 to 2 MPa. Consequently, while cells with both co-rolled and freestanding films showed comparable discharge capacities (˜191 mAh g⁻¹) at 75 MPa (FIG. 27B), a cell with co-rolled film showed a much higher discharge capacity than that with freestanding films (177 vs. 141 mAh g⁻¹) at 2 MPa (FIG. 27C). The in situ EIS-DRT analysis further confirmed the different behavior of their resistance evolution, where the cell assembled with co-rolled film maintained lower SSE-positive electrode resistance than that with freestanding films during charge/discharge at 2 MPa (FIG. 28). Thus, these electrochemical results imply that co-rolled film may be less susceptible to void formation and contact loss in SSE-positive electrode interface than freestanding films, thereby exhibiting lower resistance and delivering higher capacities at reduced stack pressure.

### Electrochemical Performance of Co-Rolled Film-Based ASSBs

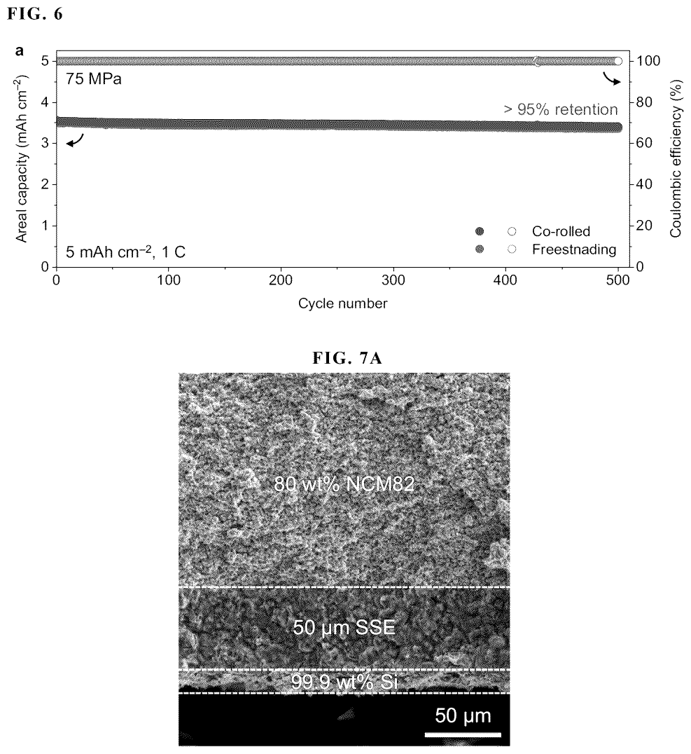

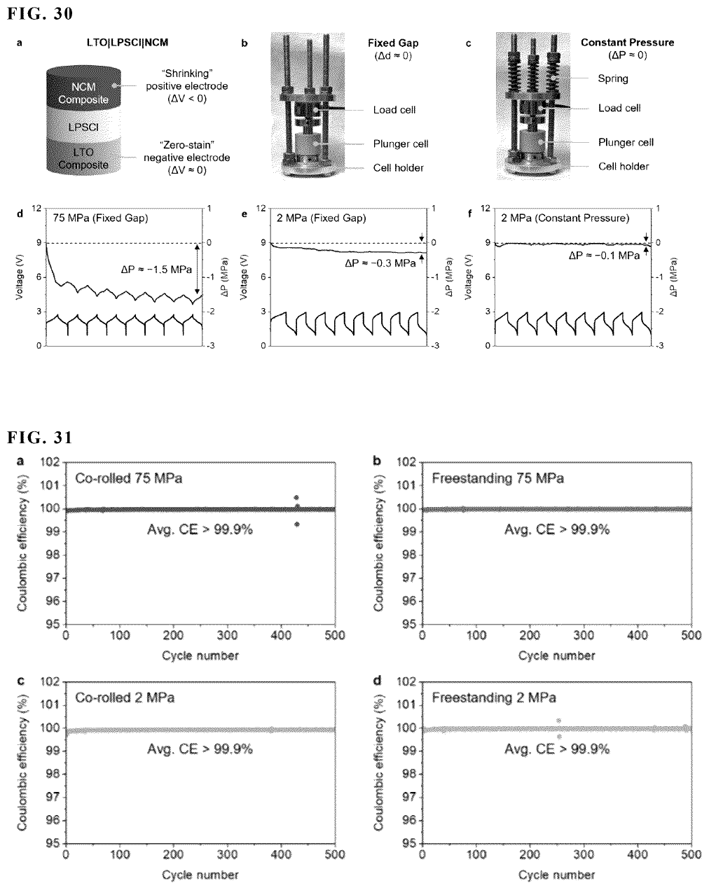

The electrochemical performance of co-rolled film and freestanding films were further evaluated at stack pressures of 75 and 2 MPa. It is critical to reduce the stack pressure as low as possible for practical implementation of ASSBs2, while the low stack pressure performance is even more aggravated with increasing CAM ratio in high loading electrodes (FIG. 29). Here, Li₄Ti₅O₁₂ (LTO) was used as a counter electrode (i) to isolate the pressure effects on positive electrode side owing to the low volume change (˜0.2%) of LTO during charging and discharging and (ii) to evaluate the performance of SSE-positive electrode structure independently by preventing the reduction of PTFE binder (<1 V vs. Li/Li+) within SSE layer. To maintain the pressure during dynamic volume change of the positive electrode, the constant pressure setup was used for 2 MPa cycling (FIG. 30). The long-term cycling at 75 MPa showed comparable cyclability with high areal capacities of 3.55 and 3.50 mAh cm⁻² and capacity retention over 95% after 500 cycles for co-rolled and free-standing films, respectively (FIG. 6). All cells delivered high Coulombic efficiencies over 99.9% for 500 cycles (FIG. 31).

There is less pressure change of the cell with co-rolled film during long-term cycling (FIG. 21). Therefore, the intimate SSE-positive electrode interface of co-rolled film constructed during co-rolling process is shown to be less vulnerable to void formation at the interface, yielding an improved cyclability at reduced stack pressure compared to the freestanding counterparts.

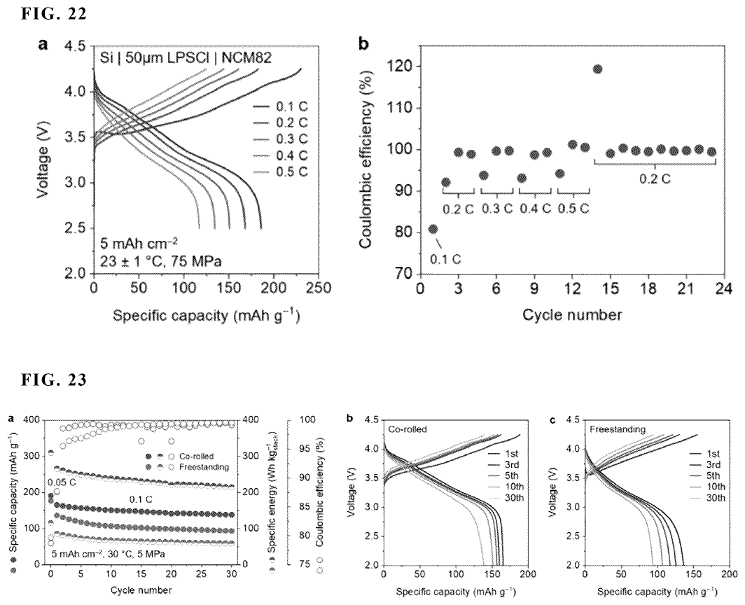

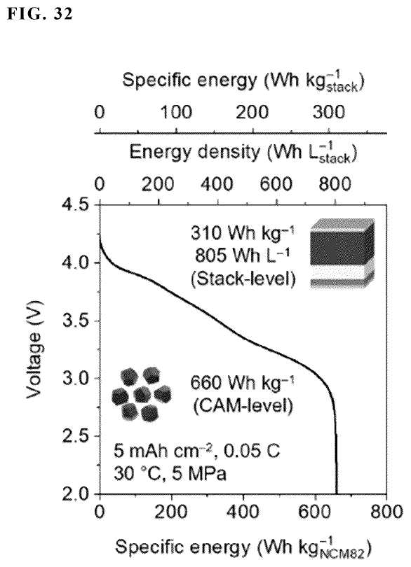

To maximize the cell energy density, the LTO composite negative electrode should be replaced by high-capacity negative electrode. Here, the co-rolled film was coupled with 99.9 wt % Si as a demonstration of high-energy density ASSBs (FIG. 7A). The cell assembled with co-rolled film and Si stably operated up to 0.5 C without shorting at 23±1° C. and 75 MPa (FIG. 7B and FIG. 22). With both reduced SSE thickness (50 μm) and high areal loading (5 mAh cm²), this cell configuration is projected to have a high specific energy of 315 Wh kg⁻¹ (FIG. 7C). In addition, a pouch cell was assembled with co-rolled film and Si (FIG. 7D) and cycled at 30° C. and stack pressure of 5 MPa over 30 cycles (FIG. 7E). The pouch cell delivered higher discharge capacities and specific energies than the freestanding counterparts (FIG. 23) and showed a high stack-level specific energy and energy density of 310 Wh kg⁻¹ and 805 Wh L-, respectively (FIG. 32).

The all-solid-state pouch cell had high stack-level specific energy (310 Wh kg⁻) and energy density (805 Wh L⁻¹) operating at 30° C. and 5 MPa. In certain aspects, the a co-rolling dry-process significantly enhances the mechanical stability of a thin SSE layer from film fabrication to cell operation along with robust SSE-positive electrode interface. By roll-pressing a thick SSE feed with a positive electrode feed, a thin SSE (50 m) and high-loading positive electrode (5 mAh cm⁻²) layers were achieved simultaneously. Unlike the conventional approach, this co-rolling dry-process eliminates the necessity for fabricating a thin SSE layer in a freestanding form, preventing mechanical failures such as crack and tear. Moreover, the resulting robust and intimate SSE-positive electrode interface not only affords remarkable physical properties of a film, but also improves cell performance at reduced operation pressure compared to the freestanding counterparts. As a result, cycling stability over 500 cycles at 2 MPa with capacity retention over 80% under high positive electrode loading of 5 mAh cm⁻² was demonstrated. A high-specific-energy ASSB pouch cell, capable of reaching up to 310 Wh kg-1 at 30° C. and 5 MPa, is achieved by employing co-rolled films.

It should be noted that further cycling induced severe current leakage due to reduction of PTFE, which requires future works on stabilizing the negative electrode interface to prevent the reduction or investigating different binders compatible with co-rolling dry-process. Table 3 below shows a summary of binders used in dry-process and potential compatibility with co-rolling dry-process based on the criteria of binder property, binding type, and fabrication method.

| | | | | | | |
|---|---|---|---|---|---|---|
| Binder | Polytetrafluoro- | Polyvinylidene | Paraffin | Ethylene-vinyl | Hydrogenated | Styrene- |
| | ethylene | fluoride | | acetate | nitrile butadiene | butadiene |
| | (PTFE) | (PVDF) | | (EVA) | rubber | rubber |
| | | | | | (HNBR) | (SBR) |
| Binder | Thermoplastic | Thermoplastic | Thermoplastic | Thermoplastic | Thermoset | Thermoset |
| property | | | | | elastomer | elastomer |
| Binding type | Fibrillated | Melted | N/A | Fibrillated | N/A | N/A |
| Fabrication | Roll/Shear | Dry spray, | Roll/Shear | Roll/Shear | Roll/Shear | Roll/Shear |
| method | | Mold-press | | | | |

In this work, we conceptualized a co-rolling approach to dry-processing ASSBs that could effectively reduce the thickness of the SSE layer with minimal risk of mechanical failure compared to the con-ventional dry-process. The co-rolled film exhibited improved physical properties due to robust SSE-positive electrode interface formed during co-rolling process. This robust interface was found to be less susceptible to void formation, significantly improving cyclability (>80% capacity retention after 500 cycles) at low stack pressure operation (2 MPa) of ASSBs compared to the freestanding counter-parts fabricated with the conventional approach. An ASSB pouch cell with high stack-level specific energy and energy density (310 Wh kg-1 and 805 Wh L-1, respectively) was also demonstrated by coupling with Si. This work opens a pathway for sustainable and scalable fabrication and interface design strategy for the practical application of ASSBs.

### Methods

### Fabrication of Co-Rolled Film

For positive electrode feed layer, polycrystalline LiNi_{0.8}Co_{0.1}Mn_{0.1}O₂(PC-NCM, NCM811, LG Energy Solution) or single crystalline LiNi_{0.82} Coo., Mn_{0.07}O₂(SC-NCM, NCM82, MSE Supplies) (200 mAh g 1), Li₆PS₅Cl (LPSCl, <1 μm, vendor A (proprietary source)), and vapor-grown carbon fiber (VGCF, >98%, Sigma-Aldrich) (80:17:3 by weight) were mixed by mortar and pestle for 30 min. The powder mixture and polytetrafluoroethylene (PTFE, <300 nm, Chemours) (100:0.5 by weight) were transferred into a 20 mL vial and vortex mixed at 3000 rpm for 3 min. The mixture was shear-mixed by mortar and pestle until a dough was formed. The dough was roll-pressed using roll-press machine (TMAXCN) at 120° C. with a fixed roller gap of 2 mm by folding and rotating, which was repeated 30 times to fibrillate PTFE binder via calendar loop. For SSE layer, 2 g of LPSCl (>95%, NEI Corporation) was ball-milled in a 50 mL zirconia jar with 75 g of zir-conia balls (5 mm diameter) sealed in an Ar-filled atmosphere to reduce particle size using TMAX-PBM planetary ball miller (TMAXCN) at 400 rpm for 2 h with 1 minute of intermittent rest time every 1 h. Ball-milling was conducted twice in total, after extracting and grinding, to homogenize particle size. With ball-milled LPSCl and PTFE (100:0.1 by weight), SSE feed layer was obtained using the same procedure as the positive electrode feed layer.

For co-rolled film, an areal weight ratio of positive electrode and SSE feed layers was fixed to 3.5:1 with the initial thickness of SSE feed layer to 600 μm. After cutting the feed layers into a 2.54 cm×2.54 cm (1 in×1 in) dimension using a hand-held punch cutter, SSE and positive electrode feed layers are stacked and roll-pressed with desired reduction temperature (120 or 30° C.) and reduction thickness (20 or 100 μm). After reaching a feed thickness of 600 μm, the reduction thickness was reduced to 10 μm until a desired positive electrode loading was achieved. The positive electrode loading of co-rolled film was calculated and controlled based on the weight ratio of SSE feed to positive electrode feed.

### Materials Characterization and Image Processing

Scanning electron microscopy (SEM) and energy dispersive X-ray spectroscopy (EDS) were collected using FEI Apreo SEM. SEM-EDS was carried out with a short exposure to the air at 23±1° C. during sample transfer to the chamber. Cells were disassembled by gently pushing the negative electrode side of the cell with a titanium rod using hydraulic press, and cross-sections were obtained by tearing or folding the sample in Ar-filled atmosphere at 23±1° C. Micro-computed tomography (CT) was collected with Zeiss/Xradia Versa 510, and the obtained images were analyzed using Amira-Avizo software. X-ray diffraction (XRD) patterns were collected using RIGAKU D2 Phaser with Cu Kα. X-ray photoelectron spectroscopy (XPS) was collected using AXIS Supra XPS by Kratos Analytical, and the spectra were ana-lyzed with CasaXPS software. Dynamic mechanical analysis (DMA) was collected using Perkin Elmer DMA 8000 in the tensile mode with a temperature scan rate of 2° C. min⁻ and frequency of 1 Hz. Tensile strength of film was obtained using a MARK-10 M5-05 force sensor in Ar atmosphere. Void segmentation was obtained with ImageJ software by adjusting the threshold of SEM images to a lower 5% of the total distribution and measuring area fraction.

### Electrochemical Characterization

Electrochemical impedance spectroscopy (EIS) was performed with an applied potential of 10 mV from 7 MHz to 0.1 Hz by recording six data points per decade of frequency using B₁₀-Logic VSP-300. The measurements were conducted at quasi-stationary potential by applying open-circuit voltage time longer than 30 min. Direct current polarization (DCP) was performed with potential biases of 0.5 V and 0.05 V for e transports in SSE layer and positive electrode layer, respectively, using the same equipment. EIS results were fitted using ZView software. Distribution of relaxation times (DRT) was per-formed by using techniques previously reported. Internal resis-tance and shelf-life were collected using Neware Battery Cycler. For Li⁺ and e⁻ transports in SSE, co-rolled film or positive electrode and SSE freestanding films were cut into a 10 mm diameter using a hand-held punch cutter with SSE side facing a die plate, placed in a 10 mm polyether ether ketone (PEEK) die and pressed at 500 MPa for 3 min with titanium plungers to form SSE|positive electrode configuration. For Li⁺ transport in the positive electrode, 60 mg of LPSCl was pressed at 300 MPa for 10 see to make a supporting layer, and co-rolled film or freestanding positive electrode film and 60 mg of LPSCI were pressed at 500 MPa for 3 min to form SSE|positive electrode|SSE layers. 50 mg of Li_{0.5}In (LiIn) powder, prepared by vortex mixing Li metal powder (FMC) and In metal powder (99.99%, MSE Supplies) of a stoichiometric ratio, was spread on both sides and pressed at 125 MPa for 1 min to form LiIn|SSE|positive electrode|SSE|LiIn electron-blocking cell configuration. For e− transport in positive electrode layer, co-rolled film with SSE layer peeled-off or free-standing positive electrode film was pressed at 500 MPa for 3 min. Li+ or e− conductivities were calculated using the following equation: σ=L (1) where L is the thickness of SSE or positive electrode layer, R is the resistance obtained from EIS or DCP measurements, and A is the cell area. For EIS, R1 was used for Li+ transport in SSE, and sum of R2 and R3 was used for Li+ transport in positive electrode (FIG. 25). For DCP, resistance was obtained by using the following equation: R=I (2) where V is the applied potential bias, and I is the current measured. Internal resistance test was conducted with Si|LPSCI|NCM82 configuration by cycling at 0.1 C from 2.5 to 4.25 V, charging to 3.7 V, and applying a pulse of different C-rates for 10 s and resting for 20 min. Shelf-life test was conducted with Si|LPSCI|NCM82 configuration by cycling at 0.1 C from 2.5 to 4.25 V, charging to 4.25 V, and resting for 100 h. Stack pressure test was conducted with LiIn|LPSCl|NCM82 configuration by cycling at 0.1 C and 2 MPa from 1.875 to 3.675 V, charging to 3.4 V, and conducting EIS by varying stack pressures monitored with a load cell calibrated with Instron Loadframe. All electrochemical characterizations were performed at the environmental temperature of 23±1° C. and stack pressure of 75 MPa, unless specified, in Ar-filled atmosphere.

### Electrochemical Performance

Si (>99.9%, 1-5 μm, Thermo Scientific) (3500 mAh g-1) was mixed with polyvinylidene fluoride (PVDF, HSV900, Kynar) as binder (99.9:0.1 by weight) and N-Methyl-2-pyrrolidone (NMP, 99.5%, Sigma-Aldrich) as solvent using a planetary mixer (Thinky) to form a slurry, which was cast on rough side of Cufoil(>99.8%, 12 μm, Gelon) using Doctor blade and dried in vacuum oven at 80° C. overnight. Li4Ti5O12 (LTO, 1.5-3 μm, NEI Corporation) composite was prepared by mixing LTO, LPSCl, VGCF (60:37:3 by weight) by mortar and pestle for 30 min. To fabricate Si|LPSCl|NCM82 cells, co-rolled film or freestanding SSE and positive electrode films were cut into a 10 mm diameter using a hand-held punch cutter, placed into a 10 mm PEEK die, and pressed at 125 MPa for 1 min. Si electrode and carbon-coated Al foil (>99.9%, 16 μm, MTI Corporation) with 10 mm diameter were placed into the negative and positive electrode sides, respectively, and the cell was pressed at 500 MPa for 3 min. The cell was cycled from 2.5 to 4.25 V at 23±1° C. and a stack pressure of 75 MPa. To fabricate LTO|LPSCl|NCM82 cells, LTO composite powder was placed into a PEEK die and pressed at 300 MPa for 10 sec to form a supporting layer. Co-rolled film or freestanding SSE and positive electrode films were placed into a die, and carbon-coated Cu (>99.9%, 9 μm, MTI Corporation) and Al foils were placed into negative and positive electrode sides, respectively. The cell was pressed at 500 MPa for 3 min and cycled from 0.95 to 2.75 V at a stack pressure of 75 MPa using fixed gap setup or 2 MPa using a constant pressure setup in 60° C. climatic chamber. To fabricate a pouch cell, co-rolled film was cut into a 2.22 cm×1.27 cm dimension using a hand-held punch cutter and placed on Si (N/P ratio of 1.4) cast on Cu foil. The edge of co-rolled film was covered with a polyethylene terephthalate (PET) frame cut into the same dimension to prevent the edge from shorting during pressurization. Al foil was placed on positive electrode side, and the cell stack was secured with Kapton tape. Al and Ni tabs were welded on Al and Cu foils, respectively. The cell was vacuum-sealed in a laminated Al bag and pressurized at 500 MPa by cold isostatic press (MTI Corporation) for 10 min. The pouch cell was cycled from 2 to 4.25 V at 30° C. in the climatic chamber and 5 MPa in an isostatic pouch cell holder by pressurizing air to control stack pressure.

It will be understood by those of ordinary skill in the art that aspects of the present disclosure can be performed within a wide equivalent range of parameters without affecting the scope of the disclosure described herein. All publications, patent applications and patents disclosed herein are incorporated by reference in their entirety.

What is claimed is:

1. A method for manufacturing a solid electrolyte-cathode assembly, comprising:
providing a plurality of cathode particles;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the solid electrolyte-cathode assembly comprises a cathode layer having a thickness less than 200 μm, wherein the cathode layer structurally supports the solid electrolyte layer;
wherein a ratio of a thickness of the cathode layer to a thickness of the solid electrolyte layer is from 1:1 to 20:1.

2. The method according to claim 1, wherein the amount of binder is less than 2% wt.

3. The method according to claim 1, wherein the amount of binder is less than 1% wt.

4. The method according to claim 1, wherein the cathode layer has a thickness of about 25 μm to about 200 μm.

5. The method according to claim 1, wherein the cathode layer has a thickness of about 50 μm to about 150 μm.

6. The method according to claim 1, wherein the solid electrolyte layer has a thickness less than about 100 μm.

7. The method according to claim 1, wherein the solid electrolyte layer has a thickness less than about 50 μm.

8. The method according to claim 1, wherein a weight ratio of the plurality of cathode particles to the solid electrolyte is from 1:1 to 10:1.

9. The method according to claim 1, wherein a ratio of a thickness of the cathode layer to a thickness of the solid electrolyte layer is from 1:1 to 10:1.

10. The method according to claim 1, wherein the method is carried out under dry processing conditions.

11. The method according to claim 1, wherein the co-rolling of the cathode particles is carried out at a temperature of from about room temperature to about 120° C.

12. The method according to claim 1, wherein the cathode particles have an average particle size of 0.1 μm to 20 μm.

13. A method for manufacturing a solid electrolyte-cathode assembly, comprising:
providing a plurality of cathode particles, wherein the cathode particles have an average particle size of 0.1 μm to 20 μm;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the co-rolling process is conducted at a speed of about 1 m/min to 10 m/min,
wherein the co-rolling produces a network-reinforced interface between the solid electrolyte and the cathode in the solid electrolyte-cathode assembly,
wherein the solid electrolyte-cathode assembly comprises a cathode layer having a thickness of more than 10 μm and less than 200 μm;
wherein an amount of the binder is less than 1%, such that contact between the cathode layer and the solid electrolyte layer is increased; and
wherein a ratio of a thickness of the cathode layer to a thickness of the solid electrolyte layer is from 1:1 to 20:1.

14. The method according to claim 13, wherein a weight ratio of the plurality of cathode particles to the solid electrolyte is from 1:1 to 10:1.

15. The method according to claim 13, wherein a ratio of a thickness of the cathode layer to a thickness of the solid electrolyte layer is from 1:1 to 10:1.

16. A solid electrolyte-cathode assembly, prepared by:
providing a plurality of cathode particles;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the solid electrolyte-cathode assembly comprises a cathode layer having a thickness of more than 10 μm and less than 200 μm;
wherein the solid electrolyte-cathode assembly does not have a current collector;
wherein an amount of the binder is less than 1%, such that contact between the cathode layer and the solid electrolyte layer is increased; and
wherein a ratio of a thickness of the cathode layer to a thickness of the solid electrolyte layer is from 1:1 to 20:1.

17. The solid electrolyte-cathode assembly according to claim 16, wherein a weight ratio of the cathode particles to the solid electrolyte is from 1:1 to 10:1.

18. The solid electrolyte-cathode assembly according to claim 16, wherein a ratio of a thickness of the cathode layer to a thickness of the solid electrolyte layer is from 1:1 to 10:1.

19. An all-solid-state battery comprising the solid electrolyte-cathode assembly according to claim 16.

20. An all-solid-state battery according to claim 19, wherein the all-solid-state battery operates at a stack pressure of about 2 MPa or lower.
